(19) United States
(12) Patent Application Publication
(10) Pub. No.: US 2013/0212343 A1
(43) Pub. Date: Aug. 15, 2013

(54) DATA PROCESSING METHOD, DATA PROCESSING APPARATUS, AND DATA PROCESSING PROGRAM

(71) Applicants: Yusuke Morita, Yokohama (JP); Yukio Nakano, Oyama (JP)

(72) Inventors: Yusuke Morita, Yokohama (JP); Yukio Nakano, Oyama (JP)

(21) Appl. No.: 13/642,433

(22) PCT Filed: Feb. 28, 2011
(86) PCT No.: PCT/JP2011/001143

§ 371 Date: Dec. 26, 2012

(30) Foreign Application Priority Data
Apr. 22, 2010 (JP) 2010-098552

(51) Int. Cl. G06F 3/06

(52) U.S. Cl. CPC G06F 3/0656
USPC 711/159

(57) ABSTRACT

Buffer management unit selects the input and output buffer to be set as a replacement target referring to the input and output buffers in order and calculates the number of times of replacement execution for the input and output buffer and reference speed for referring to the input and output buffers in order. At execution of pre-write processing, the pre-write management unit selects, according to position information of the input and output buffer subjected to the last pre-write processing, position information, and the number of times of replacement execution, the input and output buffer to be set as a target of the present pre-write processing. When updated data is present in the input and output buffer, the pre-write management unit writes the data in the secondary storage device and executes the next pre-write processing according to the reference speed.

### CROSS-REFERENCE TO RELATED APPLICATIONS

This application is based upon and claims the benefit of priority from the prior Japanese Patent Application No. 2010-098652, filed on Apr. 22, 2010; the entire contents of which are incorporated herein by reference.

### TECHNICAL FIELD

The present invention relates to a data processing method, a data processing apparatus, and a data processing program for a system including a buffer management component.

### BACKGROUND ART

Software of a database management system (DBMS) or the like temporarily stores, in executing data processing, data in a buffer pool on a main storage device for each unit called page in order to supplement differences in processing speed and transfer speed and realize an increase in speed of the processing. However, all data cannot always be stored on the buffer pool. Therefore, data highly likely to be used is stored on the buffer pool by a buffer management function. Pages other than pages including the data highly likely to be used are stored in a secondary storage device or the like. Replacement processing for replacing the pages with pages on the buffer pool is performed according to necessity.

The replacement processing includes both processing for writing a page on the buffer pool in the secondary storage device or the like and reading necessary data from the secondary storage device in a page unit and processing for reading necessary data from the secondary storage device in a page unit without performing write from the buffer pool.

In the replacement processing, as an algorithm for performing resource allocation on a buffer, for example, selecting a page to be set as a replacement target on the buffer pool, there are LRU (Least Recently Used) and Generalized CLOCK (hereinafter, GCLOCK).

The LRU is summarized in Description of the Related Art of U.S. Pat. No. 7,096,321. Details of the GCLOCK are described in pp. 17 and the like of Principles of database buffer management (Wolfgang Effelsberg, Theo Haerder: ACM Trans. Database Syst., Vol. 9, No. 4. (December 1984), pp. 560-595).

When the buffer management function carries out the replacement processing, first, the buffer management function searches for a page to be set as a replacement target on the buffer pool. After the page to be set as a replacement target is determined as a result of the search, the buffer management function determines whether the page is updated after being read in the buffer pool. As a result of the determination, when the page has been updated, the buffer management function applies write processing for writing the page to be set as a replacement target to a storage device other than a main storage such as the secondary storage device.

Thereafter, the buffer management function carries out read processing for reading necessary data on the buffer pool in a page unit from the storage device subjected to the write processing. In other words, in the replacement processing, when the write processing occurs, access response to data necessary for processing is longer because of the write processing compared with access response at the time when the write processing does not occur.

As a method of improving access response to specific data, it is conceivable to complete the page write processing in advance before an access request is generated. In this regard, JP-A-2001-101080 discloses a technique for writing, asynchronously with the buffer management function, a page required to be written when a page is replaced (hereinafter referred to as “dirty page”). In the technique disclosed in JP-A-2001-101080, all dirty pages are written asynchronously with the buffer management function. Such processing for writing the dirty page beforehand and asynchronously is referred to as pre-write processing.

In the pre-write processing, after all the dirty pages are written, when data included in a page present on the buffer pool is updated before the buffer management function sets the page as a replacement target, the page becomes a dirty page again. Therefore, there is a first problem in that the write processing for the page occurs when the buffer management function sets the page as a replacement target thereafter.

In the case of the pre-write processing for writing all the dirty pages, it is likely that update of a specific page present on the buffer pool and the write processing for the page are repeated before the buffer management function sets the page as a replacement target. In this case, the pre-write processing effective for the specific page is only the pre-write processing executed immediately before the page is set as a replacement target. There is a second problem in that the write processing that occurs in the pre-write processing executed earlier leads to an increase in overhead in an entire system that executes the pre-write processing.

In order to solve the second problem, it is conceivable to adopt a method of appropriately managing the number of pages written in the pre-write processing performed once and setting, as a processing target of the pre-write processing, only a page to be set as a replacement target by the buffer management function immediately after execution of the pre-write processing.

In the related art, a method of selecting a replacement target page is different for each algorithm for allocating resources on a buffer. Therefore, in realizing the solving method explained above, a different processing method for the pre-write processing is necessary for each algorithm.

In the GCLOCK, pages stored on the buffer pool are managed as a circular list in which the order of the pages is fixed. When the page replacement processing occurs, pages, which could be a replacement target, scattered on the circular list are searched by a CLOCKHAND that points the pages on the circular list while tracking the pages in order.

Specifically, in buffer management to which the GCLOCK is applied, in order to set, as a processing target of the pre-write processing, only a page to be set as a replacement target in the buffer management function immediately after execution of the pre-write processing, it is necessary to set, as a processing target of the pre-write processing, only a page located near a page pointed by the CLOCKHAND immediately after the execution of the pre-write processing.

For example, when a difference between a position on the circular list of a page set as a processing target of the pre-write processing and a position on the circular list of a page pointed by the CLOCKHAND is large, page write processing occurs in the buffer management function.

This example is specifically explained in detail with reference to the drawings. FIG. 15 shows an example in which the page write processing is caused by the buffer management function. FIG. 15 shows diagrams showing an example of the same circular list. (b) in FIG. 15 shows a state of the circular list after N hours from (a) in FIG. 15. At a point of (a) in FIG. 15, a CLOCKHAND 1500 points a page 1501. The pre-write processing is executed targeting a page group (pages in a dotted line rectangle) of a page 1503 to a page 1504.

In the pre-write processing, since the page group of the pre-write target includes pages for which the write processing is necessary, the write processing for the relevant pages is executed. The pages for which the write processing is necessary include the page 1503 and the page 1504 that could be a target of page replacement. In other words, the pre-write processing for the page 1503 and the page 1504 in which updated data is stored is executed before the CLOCKHAND 1500 points the pages.

However, in the example shown in FIG. 15, the write processing is necessary between the page 1501 and the page 1503 as well and the page 1502 that could be a target of page replacement is present. Therefore, at a point of (b) in FIG. 15, when the CLOCKHAND 1500 points the page 1502, the buffer management function executes the write processing on the page 1502 in which updated data is stored.

Concerning an amount of pages to be written in the pre-write processing, if the write processing for a large amount of pages is executed in one pre-write processing, a problem same as the first problem occurs. In this case, a page becomes a dirty page again before being set as a replacement target by the buffer management function and, when the buffer management function sets the page as a replacement target, the write processing is necessary.

This example is specifically explained with reference to FIG. 16. FIG. 16 shows diagrams showing an example of the same circular list. (b) in FIG. 16 shows a state of the circular list N hours after (a) in FIG. 16. (c) in FIG. 16 shows a state of the circular list M×N hours after (b) in FIG. 16. (d) in FIG. 16 shows a state of the circular list N hours after (c) in FIG. 16.

At a point of (a) in FIG. 16, the CLOCKHAND 1500 points the page 1501 and the pre-write processing is executed on the page groups from the page 1501 to the page 1504 on the circular list. At this point, in the pre-write processing, the write processing for the page 1502, the page 1503, and the page 1504 that require the write processing and could be targets of page replacement is executed.

Since the write processing for the page 1502 is executed in the pre-write processing, at a point of (b) in FIG. 16, when the CLOCKHAND 1500 points the page 1502, data of the page 1502 is already written in the pre-write processing. Therefore, the write processing is not executed in replacement processing for the page 1502.

However, when data included in the page 1504 is updated while M×N hours elapse from the point of (b) in FIG. 16 to a point of (c) in FIG. 16, the write processing for the page 1504 is required again. Therefore, at a point of (d) in FIG. 16, when the CLOCKHAND 1500 points the page 1504, the write processing for the page 1504 is executed in the replacement processing of the buffer management function.

In realizing the solving method, an amount of pages to be set as a target of the pre-write processing is a small amount (an appropriate amount) of pages located near a page pointed by the CLOCKHAND. Therefore, the pre-write processing does not need to always operate. In other words, after the execution of the pre-write processing, the pre-write processing pauses for a fixed period. Then, the following pre-write processing only has to be executed.

However, if a period of the pause is long and the CLOCKHAND passes a range of the pre-write processing executed last time during the pre-wire pause, a page before the execution of the pre-write processing is referred to in the replacement processing. As a result, the page write processing is necessary in the replacement processing.

This example is specifically explained with reference to the drawings. FIG. 17 shows an example in which the write processing is necessary in the replacement processing because the CLOCKHAND passes a pre-write target page before the execution of the pre-write processing. FIG. 17 shows diagrams showing an example of the same circular list. (b) in FIG. 17 shows a state of the circular list after N hours from (a) in FIG. 17. (c) in FIG. 17 shows a state of the circular list after M×N hours from (b) in FIG. 17.

At a point of (a) in FIG. 17, the CLOCKHAND 1500 points the page 1501 and the pre-write processing is executed on a page group of a page located next to the page 1501 on the circular list to the page 1502. At this point, in the pre-write processing, the write processing for the page 1502 that requires the write processing and could be a target of page replacement is executed.

In the pre-write processing, the write processing for the page 1502 is executed. Therefore, at a point of (b) in FIG. 17, when the CLOCKHAND 1500 points the page 1502, the write processing for the page 1502 is not executed.

However, after the execution of the pre-write processing, the pre-write processing is not executed while M×N hours elapse from the point of (b) in FIG. 17 to the point of (c) in FIG. 17. If the CLOCKHAND 1500 is beyond the processing range of the pre-write processing executed at the point of (a) in FIG. 17, when the CLOCKHAND 1500 points the page 1503 at the point of (c) in FIG. 17, the write processing for the page 1503 is executed in the replacement processing of the buffer management function.

In contrast to such a case, if the pre-write processing always operates or the pause time is too short, a difference between a position on the circular list of a page set as a processing target of the pre-write processing and a position on the circular list of a page pointed by the CLOCKHAND increases as time elapses. A problem same as the first problem occurs. Specifically, the write processing for a page updated before being pointed by the CLOCKHAND after the pre-write processing and requiring the write processing is necessary again in the replacement processing of the buffer management function.

This example is specifically explained with reference to the figures. FIG. 18 shows an example in which the write processing is necessary. FIG. 18 shows diagrams showing an example of the same circular list. (b) in FIG. 18 shows a state of the circular list after N hours from (a) in FIG. 18. (b′) in FIG. 18 shows a state of the circular list after L×N hours from (b) in FIG. 18. (c) in FIG. 18 shows a state of the circular list after (M−L)×N hours from (b′) in FIG. 18. (d) in FIG. 18 shows a state of the circular list after N hours from (c) in FIG. 18.

At a point of (a) in FIG. 18, the CLOCKHAND 1500 points the page 1501 and the pre-write processing is executed on a page group of a page located next to the page 1501 on the circular list to the page 1502. At this point, in the pre-write processing, the write processing for the page 1502 that requires the write processing and could be a target of page replacement is executed.

In the pre-write processing, the write processing for the page 1502 is executed. Therefore, when the CLOCKHAND 1500 points the page 1502 at a point of (b) in FIG. 18, the write processing for the page 1502 is not executed in the replacement processing of the buffer management function.

However, after the execution of the pre-write processing, the pre-write processing is continuously executed while N hours elapse from the point of (a) in FIG. 18 to the point of (b) in FIG. 18. At the point of (b) in FIG. 18, the pre-write processing is executed on the page group of the page 1503 to the page 1504.

In this second pre-write processing, when the write processing for the page 1503 and the page 1504 that require the write processing and could be a target of page replacement is executed, data included in the page 1504 is updated and the page 1504 changes to a state in which the write processing is necessary while M×N hours elapse from the point of (b) in FIG. 18 to the point of (c) in FIG. 18. Then, when the CLOCKHAND 1500 points the page 1504 at a point of (d) in FIG. 18, the write processing for the page 1504 is executed again in the replacement processing of the buffer management function.

In short, it is necessary to appropriately control the pre-write processing according to the movement of the CLOCKHAND.

### SUMMARY OF THE INVENTION

The present invention has been devised in view of the problems of the related art and it is an object of the present invention to provide a data processing method, a data processing apparatus, and a data processing program that can appropriately control the pre-write processing according to the movement of the CLOCKHAND that refers to a plurality of input and output buffers in order.

In order to attain the object, the present invention provides a data processing method for a computer including a main storage device including a plurality of input and output buffers that temporarily store data, a secondary storage device that stores the data, a buffer management unit that manages replacement processing for the data temporarily stored in the input and output buffers and the data stored in the secondary storage device, and a pre-write management unit that manages pre-write processing for performing pre-write before the data stored in the input and output buffers is written by the buffer management unit, the data processing method including: a step of the buffer management unit selecting, in carrying out the replacement processing, an input and output buffer to be set as a replacement target of the data while referring to the input and output buffers in order; a step of the buffer management unit measuring the number of times of replacement execution, which is the number of times replacement of data is applied to the input and output buffers per a predetermined time; a step of the buffer management unit calculating reference speed for referring to, in order, the data stored in the plurality of input and output buffers per the predetermined time; a step of the pre-write management unit detecting an execution opportunity of the pre-write processing and selecting, on the basis of position information of the input and output buffer subjected to the pre-write processing last time, position information of the input and output buffer currently referred to by the buffer management unit, and the number of times of replacement execution, the input and output buffer to be set as a target of the present pre-write processing; a step of the pre-write management unit writing, when updated data is present in the input and output buffer serving as a candidate to be subjected to the pre-write processing, the data stored in the input and output buffer; and a step of the pre-write management unit determining, on the basis of the reference speed, a processing execution opportunity of the next pre-write processing.

According to the present invention, it is possible to appropriately control the pre-write processing according to an action for referring to the plurality of input and output buffers and realize improvement of the throughput of a system.

### BRIEF DESCRIPTION OF THE DRAWINGS

FIG. 1 is a diagram showing a configuration of a first embodiment of the present invention;

FIG. 2 is a flowchart for explaining processing contents of a start-position determination unit in the first embodiment;

FIG. 3 is a diagram showing an example of a circular list of a page set in the present invention;

FIG. 4 is a flowchart for explaining processing contents of a number-of-targets determination unit in the first embodiment;

FIG. 5 is a diagram showing an example of a number of times of replacement execution table in the present invention;

FIG. 6 is a flowchart for explaining processing contents of a number-of-times-of-replacement-execution acquisition unit in the first embodiment;

FIG. 7 is a flowchart for explaining processing contents of a pre-write execution unit in the first embodiment;

FIG. 8 is a flowchart for explaining processing contents of a start-opportunity determination unit in the first embodiment;

FIG. 9 shows diagrams showing an overview of processing of the present invention in the first embodiment;

FIG. 10 is a diagram showing a configuration of a second embodiment in the present invention;

FIG. 11 is a flowchart for explaining processing contents of a pre-write execution unit in a second embodiment;

FIG. 12 is a flowchart for explaining processing contents of a pre-write startup unit in the second embodiment;

FIG. 13 is a flowchart for explaining processing contents of the pre-write execution unit performed when a third embodiment is applied to the first embodiment;

FIG. 14 is a flowchart for explaining processing contents of the pre-write execution unit performed when the third embodiment is applied to the second embodiment;

FIG. 15 shows diagrams showing an example of the pre-write processing in which page write processing occurs in buffer management;

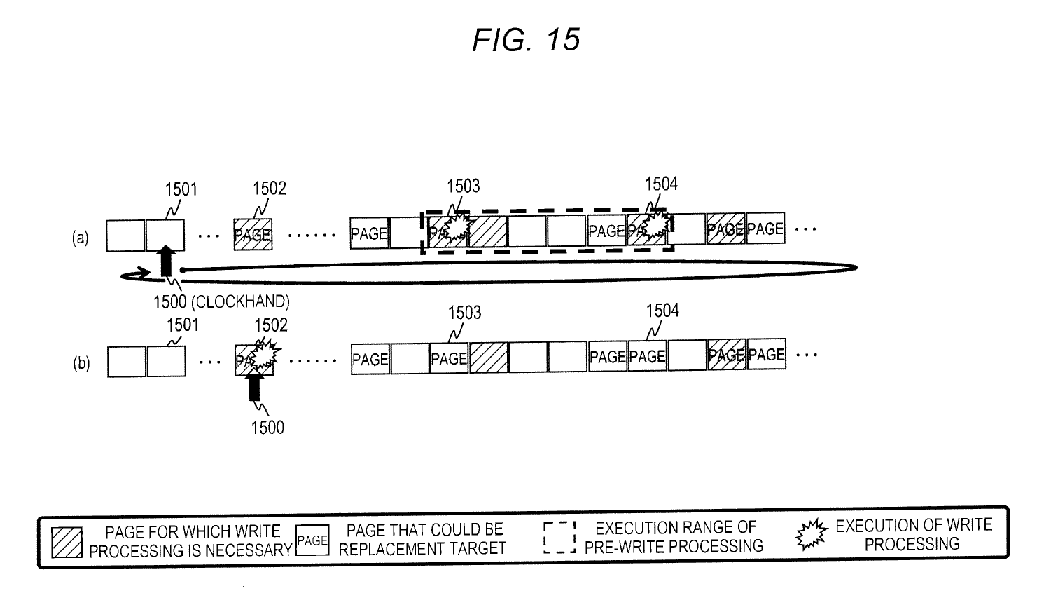

FIG. 16 shows diagrams showing an example of the pre-write processing in which the page write processing occurs in the buffer management;

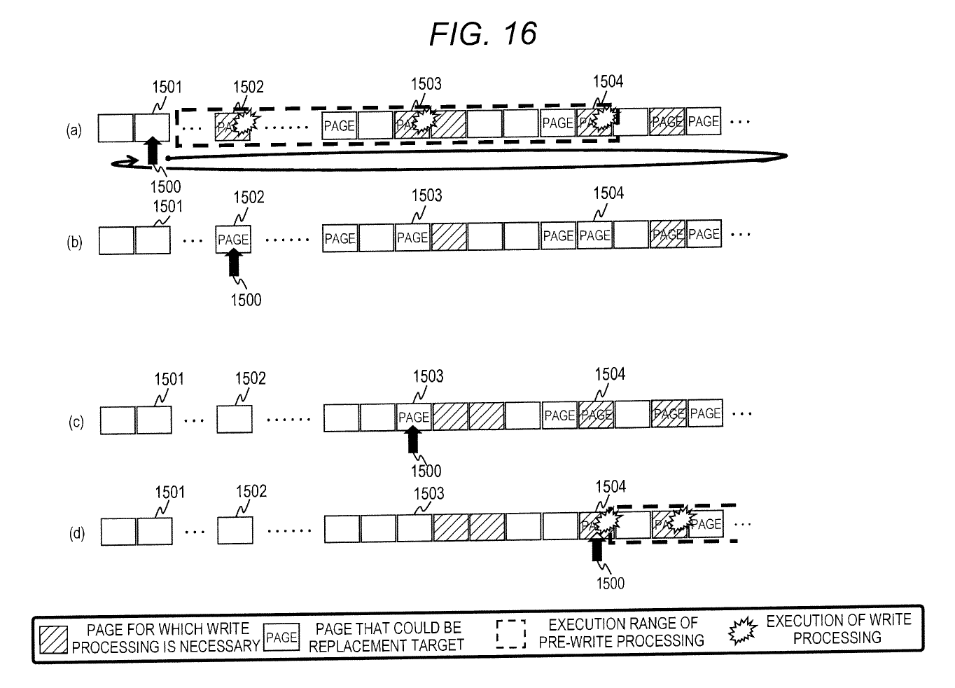

FIG. 17 shows diagrams showing an example of the pre-write processing in which the page write processing occurs in the buffer management; and

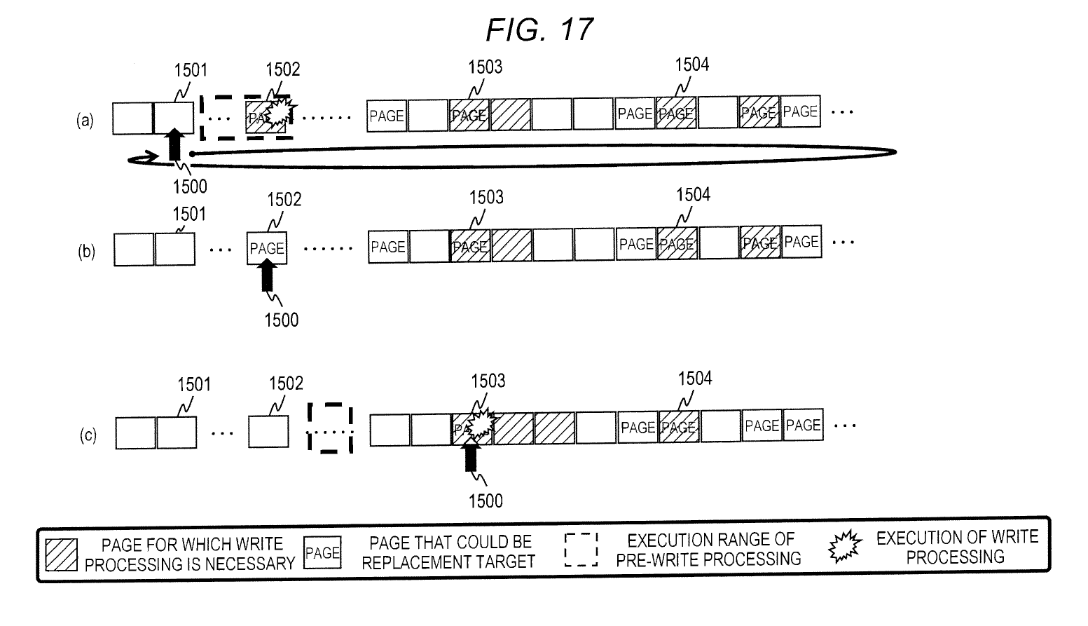

FIG. 18 shows diagrams showing an example of the pre-write processing in which the page write processing occurs in the buffer management.

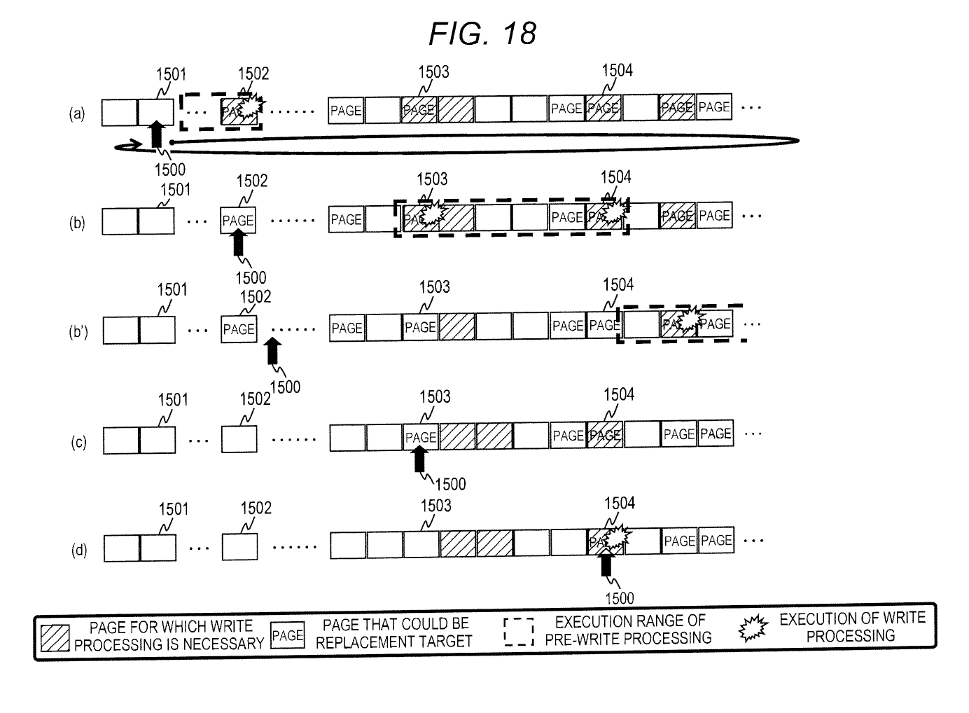

### DETAILED DESCRIPTION OF THE INVENTION

### First Embodiment

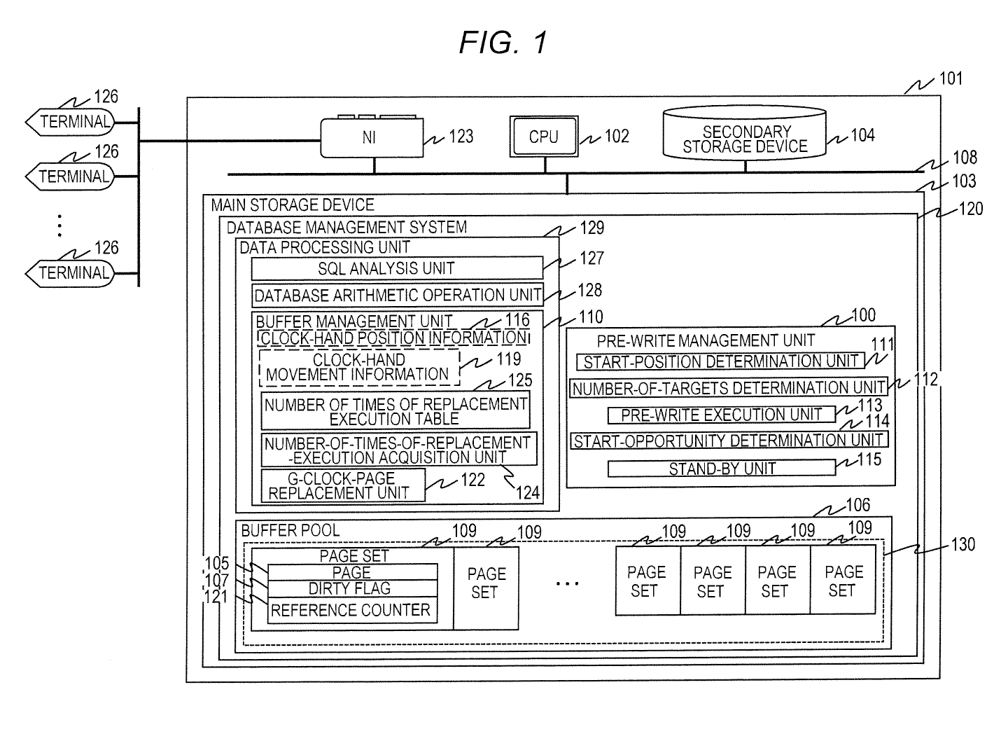

A first embodiment of the present invention is explained below with reference to FIG. 1.

FIG. 1 is an overall configuration diagram of a computer system to which the present invention is applied. A database management system 120 incorporating a pre-write management unit 100 is constructed in a data management server 101. The data management server 101 is realized by a configuration in which a CPU (Central Processing Unit) 102 that executes various kinds of processing explained below, a main storage device 103 such as a RAM (Random Access Memory), a secondary storage device 104 such as a hard disk drive, and a network interface (hereinafter referred to as “NI”) 123 are connected via a bus 108.

A large number of terminal apparatuses 126 are connected to the data management server 101 as sources of request for access to data managed by the data management server 101.

The database management system 120 is stored on the main storage device 103. The database management system 120 includes a data processing unit 129, the pre-write management unit 100, and a buffer pool 106. The CPU 102 functions as a controller to cause the data processing unit 129 and the pre-write management unit 100 to respectively execute processing. Specifically, the CPU 102 starts up a computer program included in the database management system 120 to form the data processing unit 129, the pre-write management unit 100, and the buffer management unit 110 on the database management system 120.

The buffer pool 106 is a data region for temporarily storing, in a page unit, data stored in the secondary storage device 104. The buffer pool 106 is configured as a storage region for a plurality of input and output buffers. The buffer pool 106 stores a circular list 130 of page sets 109 including pages 105 and reference counters 121 and dirty flags 107 corresponding to the pages 105. The page sets 109 are stored in the buffer pool 106 to correspond to the respective input and output buffers.

The data processing unit 129 includes an SQL analysis unit 127, a database arithmetic operation unit 128, and a buffer management unit 110.

The buffer management unit 110 includes a GCLOCK-page replacement unit 122 and a number-of-times-of-replacement-execution acquisition unit 124. The buffer management unit 110 has, as statistic information referred to by the pre-write management unit 100, CLOCKHAND position information 116, CLOCKHAND movement information 119, and a number of times of replacement execution table 125 for managing the number of times of occurrence of replacement processing that occurs in buffer management per a unit time.

In this case, for example, the buffer management unit 110 executes, in parallel to the pre-write management unit 100, buffer management processing for selecting, out of the plurality of input and output buffers, an input and output buffer to be set as a replacement target for replacing data of the input and output buffer with data of the secondary storage device 104. In a process of the execution of the buffer management processing, the buffer management unit 110 counts, as the number of times of replacement execution, the number of times an input and output buffer (page set 109) to be set as a replacement target is found in selecting the input and output buffer (page set 109) to be set as a replacement target.

The buffer management unit 110 refers to, in order, information (the pages 105, the reference counters 121, and the dirty flags 107) stored in the plurality of input and output buffers. The buffer management unit 110 calculates speed of referring to the information stored in the plurality of input and output buffers on the basis of the information of the input and output buffer referred to and the counted number of times of replacement execution.

The database management system 120 receives an SQL, which is a database inquiry request from the terminal apparatus 126. The database management system 120 specifies, in the SQL analysis unit 127, requested data by performing syntax analysis processing, meaning analysis processing, and optimization processing for determining an optimum access path of database access. The database management system 120 executes, in the database arithmetic operation unit 128, a database arithmetic operation such as join according to the SQL request and issues an acquisition request for necessary data to the buffer management unit 110.

When the requested data is already read in the buffer pool 106, the buffer management unit 110 increments the reference counter 121 corresponding to the page set 109 to which the data belongs. The buffer management unit 110 returns the requested data present in the buffer pool 106 to an access request source.

Conversely, when the data requested from the database arithmetic unit 128 is absent in the buffer pool 106, the buffer management unit 110 reads out the requested data from the secondary storage device 104 and stores the read-out data in the page set 109 in the buffer pool 106. The buffer management unit 110 returns the read-out data to the access request source.

When the requested data is not read in the buffer pool 106, the buffer management unit 110 selects, in the GCLOCK-page replacement unit 122, the page set 109 to be set as a replacement target out of the page sets 109 present on the buffer pool 106. The buffer management unit 110 reads the requested data from the secondary storage device 104 and stores the read data in the replacement target page set 109. The buffer management unit 110 returns the read data to the access request source. The buffer management unit 110 sets “1” in the reference counter 121 corresponding to the replacement target page set 109 and resets the dirty flag 107 determining that there is no difference of data between the replacement target page set 109 and the secondary storage device 104.

As a selection method for the replacement target page set 109, the buffer management unit 110 refers to the reference counter 121 corresponding to the page set 109 pointed by a pointer called CLOCKHAND managed by the buffer management unit 110 and, when a value of the reference counter is equal to or smaller than a threshold set in advance, sets the page set 109 as a replacement target. For example, when the threshold is “0” and the value of the reference counter corresponding to the page set 109 pointed by the pointer called CLOCKHAND is equal to or smaller than “0”, the buffer management unit 110 sets the page set 109 as a replacement target. At this point, when the dirty flag 107 corresponding to the replacement target page set 109 is set (when updated data is present), the buffer management unit 110 writes data of the page 105 corresponding to the page set 109 in the secondary storage device 104 as updated data. Thereafter, the buffer management unit 110 stores the data read out from the secondary storage device in the replacement target page set 109.

When the value of the reference counter 121 corresponding to the page set 109 is larger than the threshold set in advance (e.g., “0”), the buffer management unit 110 decrements the reference counter 121 corresponding to the page set 109 and causes the CLOCKHAND to point the page set 109 located next to the page set 109 on the circular list 130. Thereafter, the buffer management unit 110 sequentially repeats the same processing until an appropriate page set 109 is selected as a replacement target.

The pre-write management unit 100 in the first embodiment is explained. As explained above, the buffer management unit 110 is configured to write the stored data in the secondary storage device 104 when the corresponding dirty flag 107 is set concerning the page set 109 to be set as a replacement target. The pre-write management unit 100 in the first embodiment executes and manages the pre-write processing for writing the dirty data in the secondary storage device 104 before the buffer management unit 110 writes the data stored in the page set 109.

The pre-write management unit 100 includes a start-position determination unit 111, a number-of-targets determination unit 112, a pre-write execution unit 113, a start-opportunity determination unit 114, and a stand-by unit 115. The pre-write management unit 100 is configured to operate independently from and in parallel to the data processing unit 129. Specifically, before the page 105 for which the dirty flag 107 is set in the page set 109 stored in the buffer pool 106 is written in the secondary storage device 104 by the buffer management unit 110, the pre-write management unit 100 writes the page 105 on the basis of a predetermined condition.

When updated data (page 105) is present in the page set 109 likely to be selected as a replacement target by the buffer management unit 110, the pre-write management unit 100 executes, referring to the CLOCKHAND position information 116, the CLOCKHAND movement information 119, and the number of times of replacement execution table 125, processing for selecting a page required to be written in the secondary storage device 104 out of the page set 109 including the updated data (page 105) and writing the page.

Processing contents of the pre-write processing in the first embodiment are explained below.

First, an overview of the pre-write processing executed by the pre-write management unit 100 is explained with reference to FIG. 1.

The pre-write management unit 100 is started up according to a startup request from the database management system 120. When the pre-write management unit 100 is started up, the pre-write management unit 100 repeats processing executed in the start-position determination unit 111 to the stand-by unit 115 until a stop request from the database management system 120 is received.

In this repeated processing, first, the pre-write management unit 100 starts up the start-position determination unit 111. The start-position determination unit 111 determines, from the circular list 130 in the buffer pool 106, the page set 109 in which the pre-write execution executed by the pre-write execution unit 113 is started.

Subsequently, the pre-write management unit 100 starts up the number-of-targets determination unit 112. The number-of-targets determination unit 112 determines the number of the page sets 109 equivalent to a predetermined number to be set as a processing target in the pre-write execution executed by the pre-write execution unit 113. Thereafter, the pre-write management unit 100 starts up the pre-write execution unit 113.

The pre-write execution unit 113 determines, in the start-position determination unit 111, in order from a start position and the determined page set 109, whether it is necessary to perform the write processing for the predetermined number of the page sets 109 determined by the number-of-targets determination unit 112. The pre-write execution unit 113 writes, in the secondary storage device 104, data of the page 105 belonging to the page set 109 for which it is determined necessary to perform the write processing.

Subsequently, the pre-write management unit 100 starts up the start-opportunity determination unit 114. The start-opportunity determination unit 114 determines time of stand-by in the stand-by unit 115. Finally, the pre-write management unit 100 starts up the stand-by unit 115 and executes stand-by processing according to the stand-by time determined by the start-opportunity determination unit 114.

Specific processing executed by the respective units in the pre-write processing is explained.

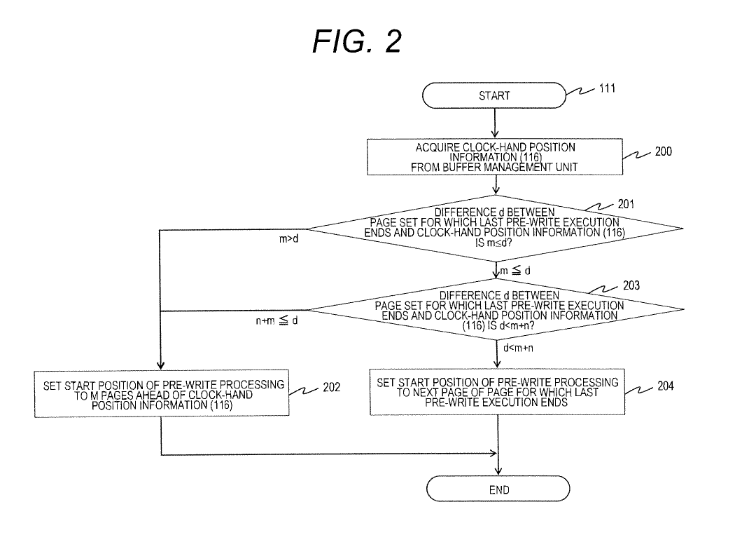

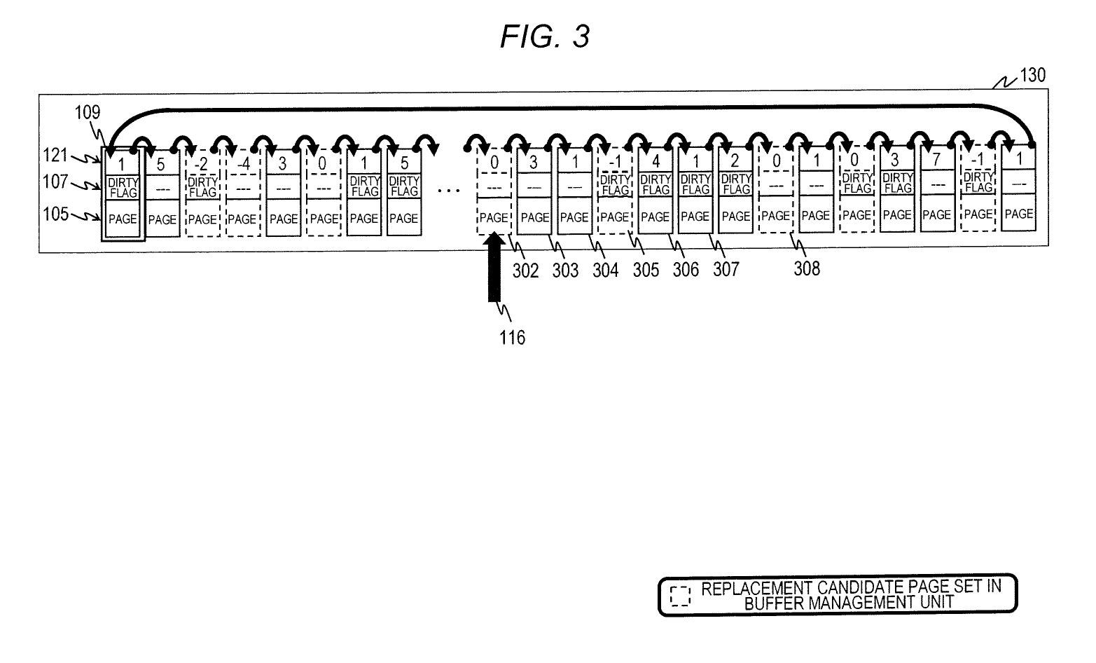

First, processing contents of the start-position determination unit 111 are explained with reference to FIGS. 2 and 3.

FIG. 2 is a flowchart for explaining the processing contents of the start-position determination unit 111.

FIG. 3 is a schematic diagram showing an example of the circular list 130 of the page sets 109 stored in the buffer pool 106 shown in FIG. 1 and representing a relation between the CLOCKHAND position information 116 and the circular list 130.

The page sets 109 include the pages 105 and the reference counters 121 and the dirty flags 107 corresponding to the pages 105.

In the first embodiment, the CLOCKHAND position information 116 is statistic information indicating the position of the page set 109 pointed by the CLOCKHAND. In the example shown in FIG. 3, a page set 302 is set in the CLOCKHAND position information 116.

In the first embodiment, a page set in an optimum processing start position of the pre-write execution in executing the pre-write processing is a page set located ahead by a specified value m in a moving direction of the CLOCKHAND viewed from the CLOCKHAND position information 116 during the start of the pre-write execution. When a difference between the page set in the processing start position of the pre-write execution and the CLOCKHAND position information 116 is smaller than the specified value m or equal to or larger than a specified value n+m, it is determined that the pre-write processing cannot be normally continued. The specified values n and m are natural numbers (including 0). Both the specified values n and m are set by the database management system 120 or the pre-write management unit 100 or set in advance as initial values.

First, in step 200, the start-position determination unit 111 acquires the CLOCKHAND position information 116 stored in the buffer management unit 110.

Subsequently, in step 201, the start-position determination unit 111 calculates a difference d between the CLOCKHAND position information 116 and a page set for which the immediately preceding (last) pre-write execution ends. When the difference d is smaller than the specified value m, in step 202, the start-position determination unit 111 sets a page set in a processing start position of the immediately following pre-write execution in a position ahead of the CLOCKHAND position information 116 by the specified value m. The start-position determination unit 111 ends the process of the start-position determination unit 111.

When the difference d is equal to or larger than the specified value min step 201, subsequently, in step 203, the start-position determination unit 111 determines whether the difference d is equal to or larger than the specified value n+m. In other words, the start-position determination unit 111 determines whether the CLOCKHAND is not a fixed distance or more apart from the page set for which the immediately preceding pre-write execution ends.

When the difference d is equal to or larger than the specified value n+m as a result of the determination, in step 202, the start-position determination unit 111 sets a page set to be set as a processing start position of the present pre-write execution in a position ahead of the CLOCKHAND position information 116 by the specified value m. The start-position determination unit 111 ends the processing of the start-position determination unit 111.

Only when the difference d is equal to or larger than the specified value m and smaller than the specified value n+m, in step 204, the start-position determination unit 111 sets the processing start position of the present pre-write execution in the next page set of the page set for which the last pre-write execution ends. The start-position determination unit 111 ends the processing of the start-position determination unit 111 determining that the CLOCKHAND is not too apart from and has not overtook the page set for which the last pre-write execution ends.

In the example shown in FIG. 3, the specified value m is set to 2, the specified value n+m is set to 5, and the page set for which the last pre-write execution ends is set as a page set 306. The specified value m is a value set in advance used in determining a page set serving as a best processing start position of the pre-write execution. The specified value n+m is a value set in advance used in determining whether the pre-write processing can be normally continued.

In the example shown in FIG. 3, the difference d is 4 because there is a difference equivalent to four pages (page sets 303, 304, 305, and 306) between the page set 302 in the CLOCKHAND position information 116 and the page set 306 for which the last pre-write execution ends.

In this case, the difference d (“4”) is equal to or larger than the specified value m (“2”) and smaller than the specified value n+m (“5”). Therefore, it is determined that the pre-write processing can be normally continued even if the processing start position of the present pre-write execution is set in the next page set of the page set for which the last pre-write execution ends. Consequently, the page set to be set as the processing start position of the immediately following pre-write execution is set as the next page set 307 of the page set 306 for which the immediately preceding pre-write execution ends.

The processing contents of the start-position determination unit 111 are explained above.

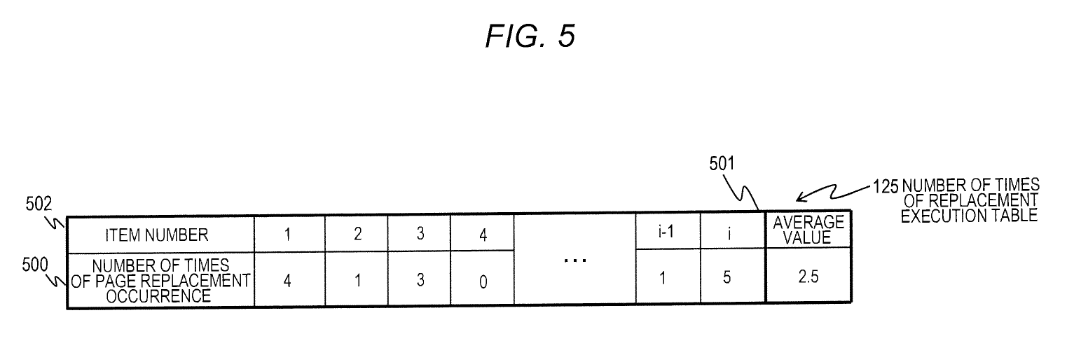

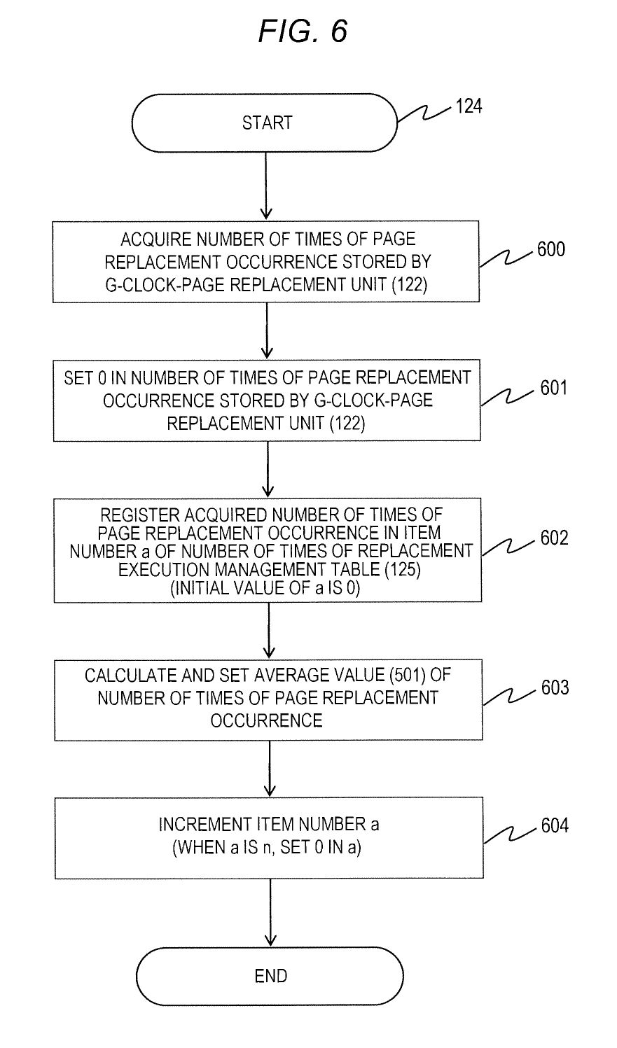

Specific processing of the number-of-targets determination unit 112 is explained below. Before the explanation, the number of times of replacement execution table 125 used by the number-of-targets determination unit 112 and processing of the number-of-times-of-replacement-execution acquisition unit 124 for creating the table are specifically explained with reference to FIGS. 5 and 6.

FIG. 5 is a conceptual diagram representing an example of the number of times of replacement execution table 125. The number of times of replacement execution table 125 includes the number of times of page replacement occurrence 500 equivalent to i times, an item number 502 corresponding to the number of times of page replacement occurrence 500, and an average number of times of page replacement occurrence 501, which is an average of the number of times of page replacement occurrence 500 equivalent to i times. The number of times of page replacement occurrence 500 is the number of times the replacement processing for the page 105 is executed in the GCLOCK-page replacement unit 122 during a unit time t.

FIG. 6 is a flowchart for explaining processing contents of the number-of-times-of-replacement-execution acquisition unit 124.

The number-of-times-of-replacement-execution acquisition unit 124 is started up at any time from the buffer management unit 110 every time the unit time t (e.g., one second) elapses.

First, in step 600, the number-of-times-of-replacement-execution acquisition unit 124 acquires the number of times of page replacement occurrence stored in the GCLOCK-page replacement unit 122. The number of times of page replacement occurrence is a value incremented every time the page replacement processing is executed in the GCLOCK-page replacement unit 122.

Subsequently, in step 601, the number-of-times-of-replacement-execution acquisition unit 124 sets 0 in the number of times of page replacement occurrence in order to measure the number of times of page replacement occurrence every time the next unit time elapses.

Subsequently, in step 602, the number-of-times-of-replacement-execution acquisition unit 124 registers the number of times of page replacement occurrence acquired in step 600 in the number of page replacement occurrence 500 corresponding to an item number “a” of the number of times of replacement execution table 125. The item number “a” is a value managed by the number-of-times-of-replacement-execution acquisition unit 124. The item number “a” is initialized to 1 when the buffer management unit 110 is started up.

Subsequently, in step 603, the number-of-times-of-replacement-execution acquisition unit 124 calculates the average number of times of page replacement occurrence 501 on the basis of the numbers of times of page replacement occurrence of an item number 1 to an item number i registered in the number of times of replacement execution 125.

Finally, in step 604, the number-of-times-of-replacement-execution acquisition unit 124 increments the item number “a”. When a value of “a” is the number-of-times-of-replacement-execution acquisition unit 124 sets 0 in “a” in order to return to the original state.

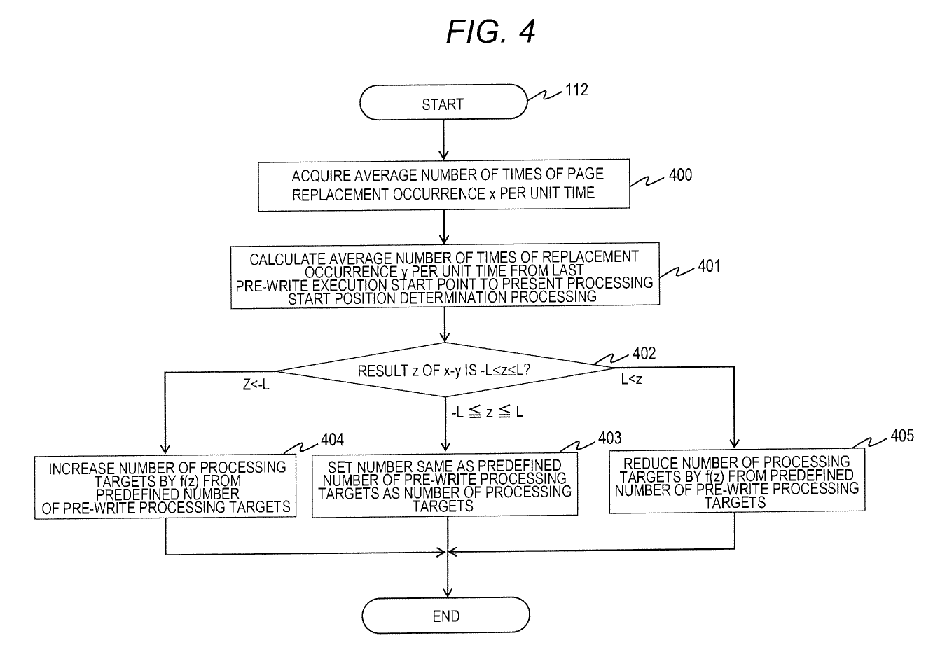

Processing contents of the number-of-targets determination unit 112 in the first embodiment are explained below with reference to FIGS. 4 and 5. Details of FIG. 5 are as explained above.

In the following explanation, a specified value L is a value set in the pre-write management unit 100 in advance in order to determine whether the number of processing targets of the pre-write execution is changed from a specified value.

A predefined number of processing targets of the pre-write execution means the number of replacement target page sets in the buffer management unit located forward in the moving direction of the CLOCKHAND viewed from the processing start position set by the start-position determination unit 111.

As shown in FIG. 4, first, in step 400, the number-of-targets determination unit 112 acquires an average number of times of page replacement occurrence 501x(in an example shown in FIG. 5, x=2.5) referring to the number of times of replacement execution table 125 of the buffer management unit 110.

Subsequently, in step 401, the number-of-targets determination unit 112 acquires the number of times of replacement processing occurrence 500 from a point when the last pre-write execution is started until the present processing start position determination processing is started and calculates an average number of times of replacement processing occurrence y during that period.

Subsequently, in step 402, the number-of-targets determination unit 112 executes subtraction (x−y) of the average number of times of page replacement processing occurrence x and the average number of times of replacement processing occurrence y and acquires a subtraction result z (z=x−y). The average number of times of page replacement processing occurrence x is a value calculated as an average number of times of replacement execution from a point further in the past than the last pre-write processing start point until a point of a start position determination processing end of the present pre-write processing.

Subsequently, the number-of-targets determination unit 112 acquires the predefined number of processing targets of the pre-write execution. When the subtraction result z is −L≦z≦L, in step 403, the number-of-targets determination unit 112 sets the number of processing targets of the page set 109 to be processed in the immediately following pre-write execution to a number same as the predefined number of processing targets of the pre-write execution.

When the subtraction result z is z<−L, in step 404, the number-of-targets determination unit 112 sets, as the number of processing targets of a page set to be processed in the present pre-write execution, a result obtained by adding f(z) from the predefined number of processing targets of the pre-write execution.

When the subtraction result z is L<z, in step 405, the number-of-targets determination unit 112 sets, as the number of processing targets of the page set 109 to be processed in the present pre-write execution, a result obtained by subtracting f(z) in the predefined number of processing targets of the pre-write execution.

The processing contents of the number-of-targets determination unit 112 are explained above.

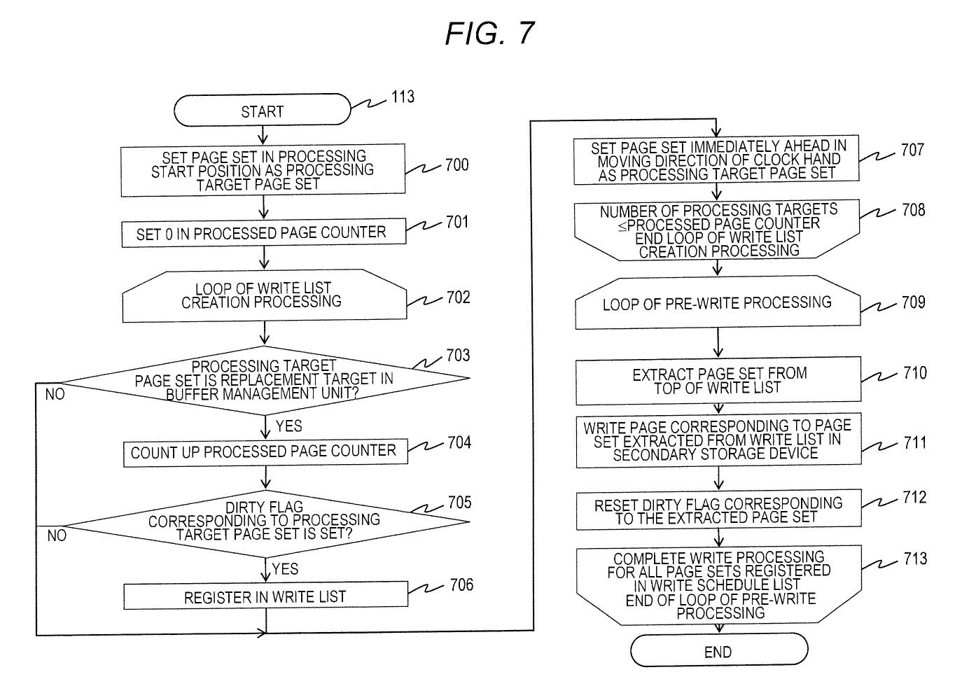

FIG. 7 is a flowchart for explaining processing contents of the pre-write execution unit 113. The processing contents of the pre-write execution unit 113 in the first embodiment are explained below with reference to the flowchart of FIG. 7.

First, in step 700, the pre-write execution unit 113 sets, as a processing target, the page set 109 in the processing start position set by the start-position determination unit 111.

Subsequently, in step 701, the pre-write execution unit 113 sets 0 in a processed page counter managed by the pre-write execution unit 113 and initializes the processed page counter. The processed page counter counts up when a page set as a processing target to carry out the pre-write execution by the number of processing targets determined by the number-of-targets determination unit 112 is set as a replacement target in the buffer management. The processed page counter is managed by the pre-write execution unit 113.

Subsequently, in step 702, the pre-write execution unit 113 repeats the processing in step 703 to step 708 until a count value of the processed page counter increases to be equal to or larger than the number of processing targets set by the number-of-targets determination unit 112.

In this repetition processing, first, in step 703, the pre-write execution unit 113 determines whether the processing target pages set 109 is set as a replacement target in the buffer management. For example, the pre-write execution unit 113 determines whether a count value of the reference counter 121 is equal to or smaller than 0 (a threshold).

For example, when the count value of the reference counter 121 is equal to or smaller than 0 (the threshold) and the processing target page set 109 is set as a replacement target (YES in step 703) in the determination in step 703, in step 704, the pre-write execution unit 113 counts up the processed page counter.

Subsequently, in step 705, the pre-write execution unit 113 determines whether the dirty flag 107 corresponding to the page set 109 is set. In other words, the pre-write execution unit 113 determines whether updated data is present in the page set 109.

When the dirty flag 107 is set (YES in step 705), in step 706, the pre-write execution unit 113 registers the processing target page set 109 in a write list managed by the pre-write execution unit 113.

Subsequently, in step 707, irrespective of the determination results in step 703 and step 705, the pre-write execution unit 113 sets, as a new processing target, the page set 109 located immediately ahead in the moving direction of the CLOCKHAND viewed from the page set 109 set as the processing target.

Subsequently, in step 709, the pre-write execution unit 113 repeats the processing in step 710 to step 713 until no page set 109 remains registered in the write list.

In this repetition processing, first, in step 710, the pre-write execution unit 113 extracts the page sets 109 one by one from the top of the write list.

Subsequently, in step 711, the pre-write execution unit 113 writes data of the page 105 corresponding to the extracted page set 109 in the secondary storage device 104 as updated data.

Subsequently, in step 712, the pre-write execution unit 113 resets the dirty flag 107 corresponding to the page set 109 extracted in step 711.

The processing contents of the pre-write execution unit 113 are explained above.

In the processing explained above, for example, in FIG. 3, when a page set in a processing start position is the page set 303 and the number of processing targets of the pre-write execution determined by the number-of-targets determination unit 112 is 2, page sets to be set as processing targets in the pre-write execution unit 113 are the page set 305 registered in the write list and a page set 308 not registered in a registration list.

In the pre-write execution unit 113, the dirty flag 107 corresponding to the page set 305 is set and the dirty flag 107 corresponding to the page set 308 is not set. Therefore, only data of the page 105 corresponding to the page set 305 is written in the secondary storage device 104.

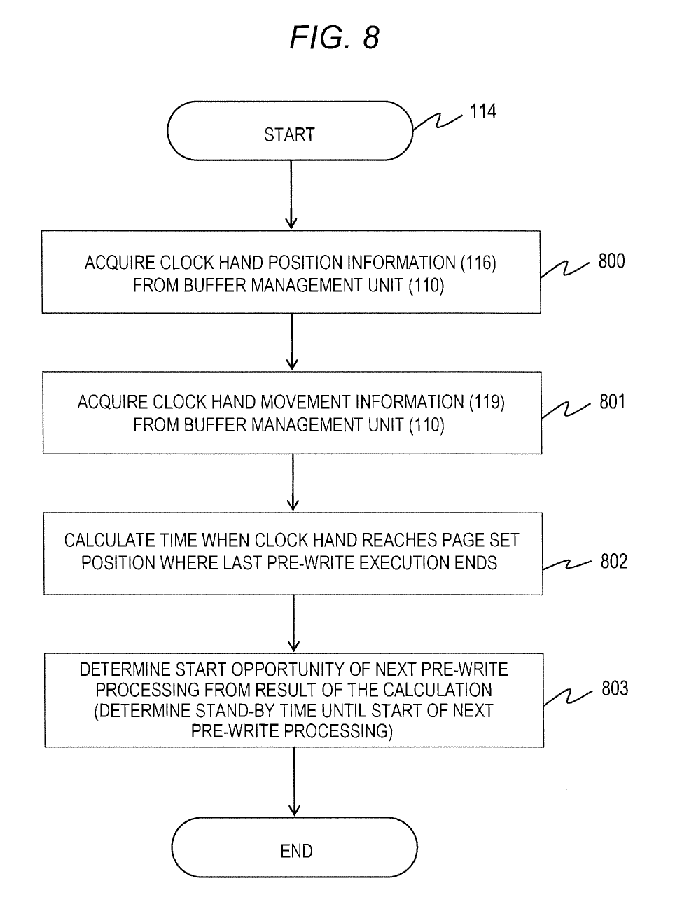

FIG. 8 is a flowchart for explaining processing contents of the start-opportunity determination unit 114.

The processing contents of the start-opportunity determination unit 114 in the first embodiment are explained with reference to the flowchart of FIG. 8.

First, in step 800, the start-opportunity determination unit 114 acquires the CLOCKHAND position information 116 from the buffer management unit 110.

Subsequently, in step 801, the start-opportunity determination unit 114 acquires the CLOCKHAND movement information 119 from the buffer management unit 110. The CLOCKHAND movement information 119 is the number of page sets pointed (referred to) by the CLOCKHAND per a unit time. In other words, the start-opportunity determination unit 114 acquires the CLOCKHAND movement information 119 from the buffer management unit 110 in order to check moving speed of the CLOCKHAND during the execution of the pre-write processing.

Subsequently, in step 802, the start-opportunity determination unit 114 determines the page set 109 the specified value m apart in a direction opposite to the moving direction of the CLOCKHAND from the position of the page set 109 set as a processing target last in the pre-write execution unit 113 in the present processing.

Further, in step 802, the start-opportunity determination unit 114 calculates, from the CLOCKHAND position information 116 acquired in step 800 and the CLOCKHAND movement information 119 acquired in step 801, time until the CLOCKHAND position information 116 reaches the position of the page set 109 determined in step 801.

Finally, in step 803, the start-opportunity determination unit 114 sets the time calculated in step 802 in the stand-by unit 115 as a stand-by time.

The processing contents of the start-opportunity determination unit 114 are explained above.

After the processing of the start-opportunity determination unit 114 ends, the stand-by unit 115 executes stand-by processing on the basis of the stand-by time set by the start-opportunity determination unit 114.

When a stop request to the pre-write management unit 100 is not received from the database management system 120 after the stand-by processing ends, the stand-by unit 115 starts up the start-position determination unit 111 again and causes the pre-write management unit 100 to start the processing.

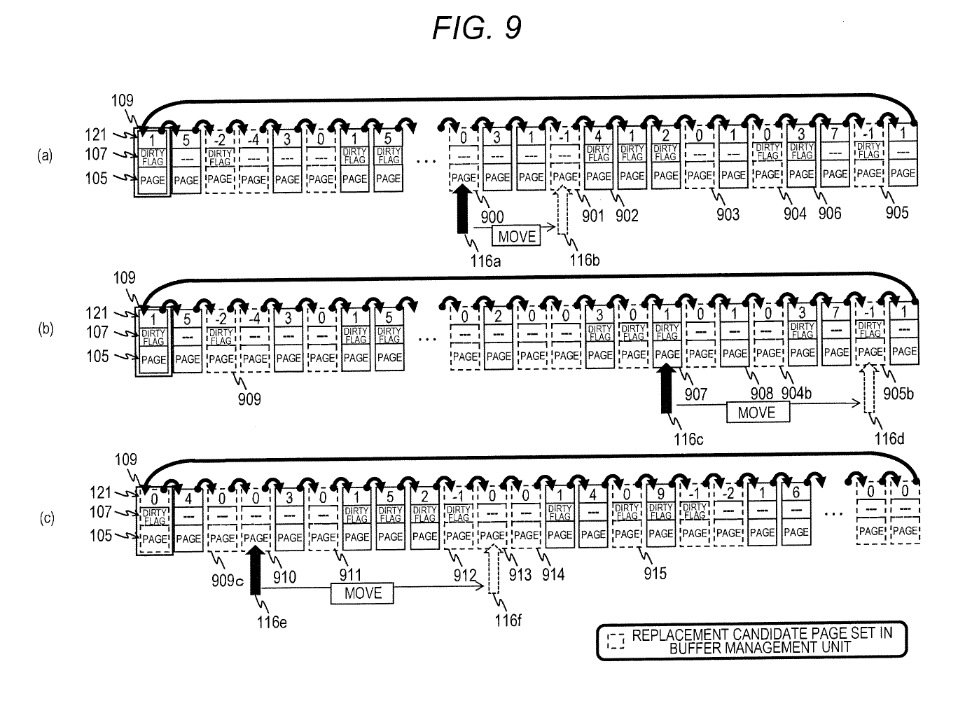

Concerning the pre-write processing in the first embodiment explained above, a processing operation of the pre-write processing is schematically explained according to various conditions with reference to FIG. 9.

In the following explanation, the specified value m is “2”, the specified value n+m is “5”, the predefined number of processing targets of the pre-write execution is “3”, the specified value L is “1”, and f(z)=[|z|/3]. The number of times of replacement execution table 125 treated in this example is the number of times of replacement execution table 125 shown in FIG. 5. A series of processing executed by the start-position determination unit 111, the number-of-targets determination unit 112, the pre-write execution unit 113, the start-opportunity determination unit 114, and the stand-by unit 115 is explained as one set of processing.

First, (a) in FIG. 9 schematically shows a state transition until the startup of the start-position determination unit 111 and the stand-by unit 115 starts the stand-by processing in the pre-write management unit 100. First, the pre-write management unit 100 acquires the CLOCKHAND position information 116a from the buffer management unit 110. In (a) in FIG. 9, at this point, the CLOCKHAND position information 116a is a page set 900.

Subsequently, the pre-write management unit 100 sets a page set for which the last pre-write execution ends as a page set 901. At this point, a difference between the page set 900 and the page set 901 is 3. This value is equal to or larger than the specified value m “2” and smaller than the specified value n+m “5”. Therefore, the pre-write management unit 100 sets a page set in a processing start position of the present pre-write execution as a page set 902.

Subsequently, the pre-write management unit 100 determines, in the number-of-targets determination unit 112, the number of processing targets of the present pre-write execution. First, the pre-write management unit 100 acquires the average number of times of page replacement occurrence 501 from the number of times of replacement execution table 125 (in this example, the average number of times of page replacement occurrence x=2.5 from the number of times of replacement execution 125 of FIG. 5).

Subsequently, the pre-write management unit 100 calculates the average number of times of replacement processing occurrence y from a point when the last pre-write execution is started until the present processing start position determination processing is started. If a calculation result is 2 (y=2), a difference (x−y) between the average number of times of page replacement occurrence x and the average number of times of replacement processing occurrence y is 0.5. Therefore, in this example, a relation between the difference and the specified value L is −L=−≦0.5≦1=L. The number of processing targets of the immediately following pre-write execution is the predefined number of processing targets of the pre-write execution (i.e., “3”).

Subsequently, processing is executed in the pre-write execution unit 113. Page sets to be set as processing targets at this point are page sets 903, 904, and 905. After resetting the dirty flags 107 corresponding to the page set 904 and the page set 905, the pre-write execution unit 113 writes data of the pages 105 corresponding to the page set 904 and the page set 905 in the secondary storage device 104.

Finally, the pre-write management unit 100 determines, in the start-opportunity determination unit 114, a stand-by time until the start-position determination unit 111 is started up next time. In starting this processing, the pre-write management unit 100 acquires the CLOCKHAND position information 116b from the buffer management unit 110.

In (a) in FIG. 9, a page set in a position pointed by the CLOCKHAND position information 116b at the start of the processing is the page set 901.

Subsequently, the pre-write management unit 100 determines a page set 906 from a last processing target page set 905 of the immediately preceding pre-write execution and the specified value m. In addition, the pre-write management unit 100 calculates, on the basis of the page set 901 pointed by the CLOCKHAND position information 116b and the CLOCKHAND movement information 119 acquired from the buffer management unit 110, a stand-by time until the CLOCKHAND position information 116 reaches the page set 906 pointed by the CLOCKHAND position information 116. Thereafter, the pre-write management unit 100 executes, on the basis of the calculated stand-by time, the stand-by processing in the stand-by unit 115 until the start-position determination unit 111 is started up again.

For example, when the CLOCKHAND movement information 119 is 2 page sets/second, since a difference between the page set 901 pointed by the CLOCKHAND position information 116b and the page set 906 is 7, the calculated stand-by time is 3.5 seconds.

Subsequently, after the stand-by processing ends, the start-position determination unit 111 is started up again. In (b) in FIG. 9, the CLOCKHAND position information 116 during startup is the position of a page set 907 and a page set for which the immediately preceding pre-write execution ends is a page set 905b. Therefore, a difference between the page set 907 and the page set 905b is 6. This value is equal to or larger than the specified value n+m “5”. Therefore, in a page set in a processing start position of the present pre-write execution, the pre-write management unit 100 sets a page set 908 the specified value m “2” ahead in the moving direction of the CLOCKHAND from the page set 907.

Subsequently, the pre-write management unit 100 determines, in the number-of-targets determination unit 112, the number of processing targets of the immediately following pre-write execution unit 113. First, the pre-write management unit 100 acquires the average number of times of page replacement occurrence 501 from the number of times of replacement execution table 125. The average number of times of page replacement occurrence 501 does not change from that shown in (a) in FIG. 9 (the average number of times of page replacement occurrence x=2.5).

Subsequently, the pre-write management unit 100 calculates an average number of times of replacement processing occurrence from a point when the last pre-write execution is started until the present processing start position determination processing is started.

In this example, the number of times of page replacement processing that occurs in the buffer management unit 110 from the point when the last pre-write execution is started until the present processing start position determination processing is started is one (the replacement processing is executed in the page set 901). Therefore, a difference z=1.5 between the calculated average number of times of replacement processing occurrence and the average number of times of page replacement occurrence 501 is L=1<1.5=z. The difference z is larger than the specified value L.

Therefore, the pre-write management unit 100 calculates the number of processing targets of the immediately following pre-write execution on the basis of f(z). At this point, since the difference z=1.5, the number of processing targets is the predefined number of processing targets of the pre-write execution=“3”.

Subsequently, processing is executed in the pre-write execution unit 113. Page sets to be set as processing targets at this point are page sets 904b, 905b, and 909. After resetting the dirty flags 107 corresponding to the page set 905b and the page set 909, the pre-write execution unit 113 writes data of the pages 105 corresponding to the page set 905b and the page set 909 in the secondary storage device 104.

Finally, the pre-write management unit 100 determines, in the start-opportunity determination unit 114, on the basis of the page set 905b pointed by a CLOCKHAND 116d during the start of this processing, the page set 909 set as the last processing target of the present pre-write execution, and the CLOCKHAND movement information 119, a stand-by time until the start-position determination unit 111 is started up next time. Thereafter, the pre-write management unit 100 executes the stand-by processing in the stand-by unit 115.

The page 105 corresponding to the page set 905 is updated according to a request from the terminal apparatus 126 from the start of the stand-by processing in (a) in FIG. 9 until the startup of the start-position-determination processing unit 111. A page set in which the dirty flag 107 is set is set as the page set 905b. Even in such a case, occurrence of the write processing in the secondary storage device 104 in the buffer management unit 110 is suppressed by executing the pre-write processing.

After the stand-by processing ends, the start-position determination unit 111 is started up again.

In (c) in FIG. 9, a page set pointed by the CLOCKHAND position information 116 during the startup is a page set 910. A page set for which the immediately preceding pre-write execution ends is a page set 909c. Therefore, a difference between the page set 910 and the page set 909c is −1. This value is smaller than the specified value m. Therefore, in a page set in a processing start position of the immediately following pre-write execution, the pre-write management unit 100 sets a page set 911 the specified value m (m=2) ahead in the moving direction of the CLOCKHAND from the page set 910.

Subsequently, the pre-write management unit 100 determines, in the number-of-targets determination unit 112, the number of processing targets of the immediately following pre-write execution. First, the pre-write management unit 100 acquires the average number of times of page replacement occurrence 501 from the number of times of replacement execution table 125. The average number of times of page replacement occurrence 501 does not change from that shown in (a) in FIG. 9 (the average number of times of page replacement occurrence x=2.5).

Subsequently, the pre-write management unit 100 calculates an average number of times of replacement processing occurrence from a point when the immediately preceding pre-write execution is started until the immediately preceding processing start position determination processing is started.

In this example, the number of times of page replacement processing that occurs in the buffer management unit 110 from the point when the immediately preceding pre-write execution is started until the immediately preceding processing start position determination processing is started is five (the replacement processing is executed in the page sets 903, 904, 905, 909, and 910). The difference z between both average numbers of times of replacement processing occurrence calculated as a result of the replacement processing is −7<z<−6. This value is smaller than the specified value −L. Therefore, the pre-write management unit 100 calculates the number of processing targets of the immediately following pre-write execution on the basis of f(z). At this point, a calculation result 2 of f(z) is added to the predefined number of processing targets of the pre-write execution. Therefore, the calculated number of processing targets is 5.

Subsequently, processing is executed in the pre-write execution unit 113. Page sets to be set as processing targets at this point are page sets 911, 912, 913, 914, and 915. After resetting the dirty flags 107 corresponding to the page set 912 and the page set 915, the pre-write execution unit 113 writes data of the pages 105 corresponding to the page set 912 and the page set 915 in the secondary storage device 104.

Finally, the pre-write management unit 100 determines, in the start-opportunity determination unit 114, a stand-by time until the start-position determination unit 111 is started immediately after the processing from the page set 913 pointed by a CLOCKHAND 116 during the start of the processing, the last processing target page set 915 of the immediately preceding pre-write execution, and the CLOCKHAND movement information 119. Thereafter, the pre-write management unit 100 executes the stand-by processing in the stand-by unit 115.

As explained above, a processing start position of the pre-write execution, the number of processing targets, and a stand-by time between the pre-write processing and the immediately following pre-write processing are appropriately determined according to an increase or a decrease in the number of times of occurrence of the replacement processing for the page 105 in the buffer management unit 110. Consequently, in the pre-write processing, the processing target page set 109 is always located forward in the moving direction of the CLOCKHAND viewed from the CLOCKHAND position information 116.

A situation is suppressed in which, after the end of the processing start opportunity determination processing, when data of the page 105 for which the write is executed in the immediately preceding pre-write execution is updated according to a request from the terminal apparatus (the user) 126 and the replacement processing for the page 105 is executed in the buffer management, the write processing of data of the page 105 is executed.

Consequently, it is possible to keep a fixed processing response of the buffer management.

Further, it is possible to improve the throughput of the computer system by reducing the number of times of execution of the write processing in the secondary storage device 104 that occurs in the entire database management system incorporating the pre-write processing.

### Second Embodiment

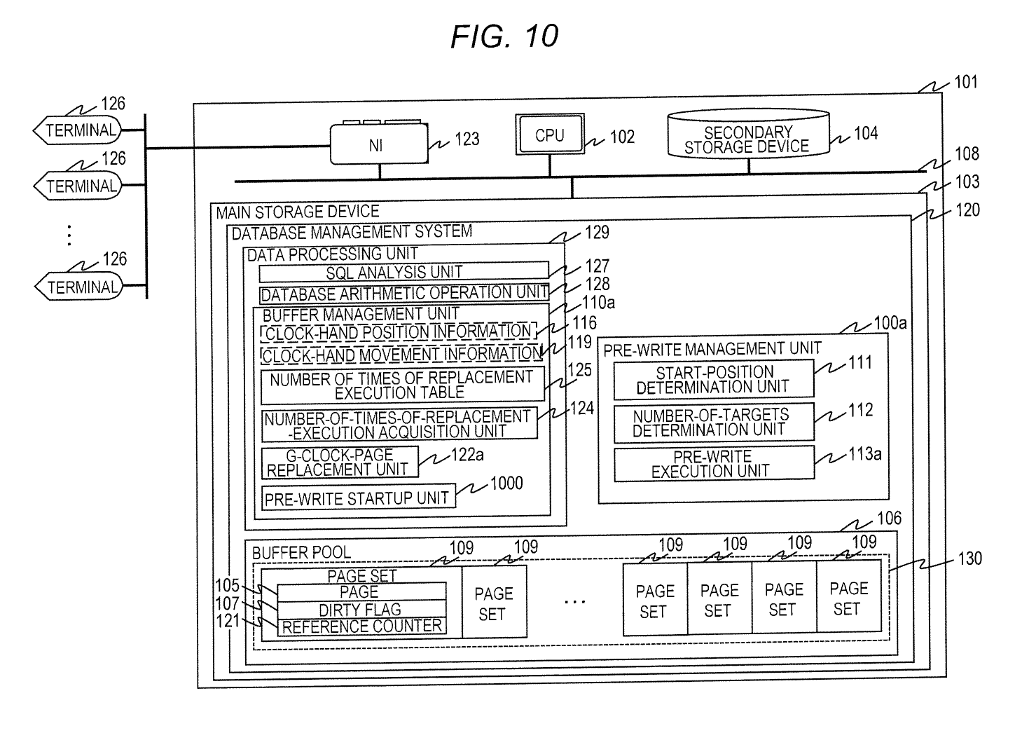

A second embodiment of the computer system to which the present invention is applied is explained with reference to FIG. 10. Differences from the first embodiment are mainly explained below. Explanation of features common to those in the first embodiment is omitted or simplified.

FIG. 10 is an overall configuration diagram related to the second embodiment of the present invention.

The database management system 120 explained in the second embodiment basically adopts a configuration same as the configuration in the first embodiment (FIG. 1). However, the configuration of a buffer management unit 110a and a pre-write management unit 100a in the data processing unit 129 is different from the configuration in the first embodiment.

The database management system 120 in the second embodiment is explained below.

In the second embodiment, the buffer management unit 110a includes a GCLOCK-page replacement unit 122a, the number-of-times-of-replacement-execution acquisition unit 124, and a pre-write startup unit 1000.

When data requested from the database arithmetic operation unit 128 is not read in the buffer pool 106, the buffer management unit 110a executes replacement processing for the page 105 in the GCLOCK-page replacement unit 122a. The buffer management unit 110a starts up the pre-write management unit 100a via the pre-write startup unit 1000 during execution of the replacement processing for the page 105.

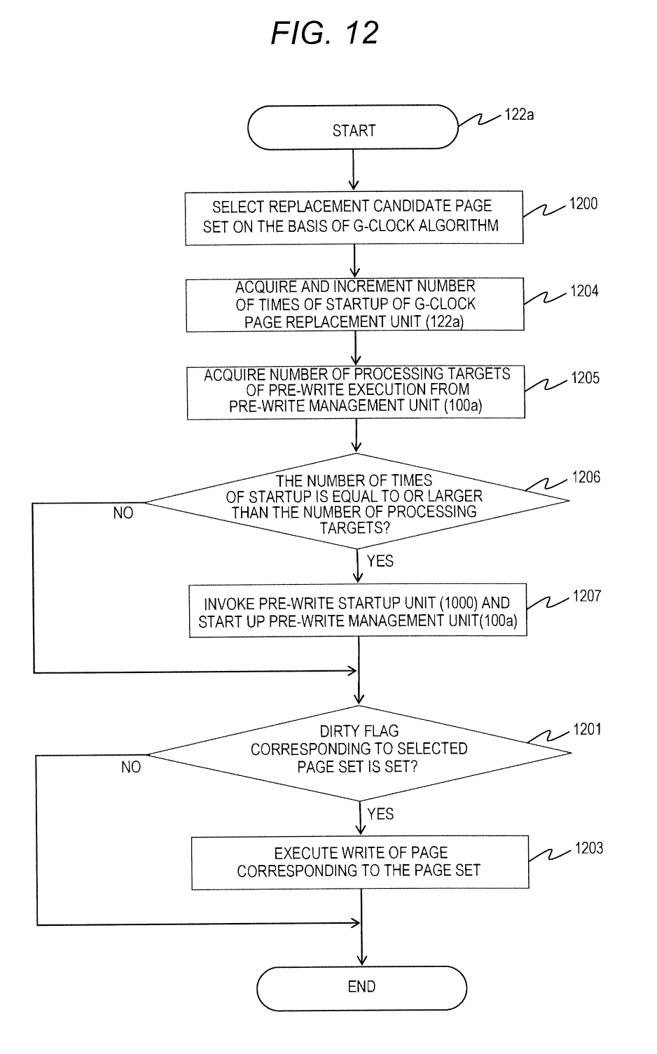

Processing contents of the GCLOCK-page replacement unit 122a and startup conditions of the pre-write management unit 100a in the second embodiment are explained with reference to a flowchart of FIG. 12.

The GCLOCK-page replacement unit 122a is started up by the buffer management unit 110a. First, in step 1200, the GCLOCK-page replacement unit 122a selects, on the basis of a GCLOCK page replacement algorithm, the replacement target page set 109 out of the page sets 109 present on the buffer pool 106.

Subsequently, in step 1204, the GCLOCK-page replacement unit 122a acquires the number of times of startup of the GCLOCK-page replacement unit 122a after the pre-write management unit 100a is started up last time and increments the number of times of startup. The number of times of startup is managed by the buffer management unit 110a and initialized to 0 during the startup of the buffer management unit 110a.

Subsequently, in step 1205, the GCLOCK-page replacement unit 122a acquires the number of processing targets of the last pre-write execution from the pre-write management unit 100a.

Subsequently, the GCLOCK-page replacement unit 122a compares the number of times of startup of the GCLOCK-page replacement unit 122a acquired in step 1204 and the number of processing targets acquired in step 1205.

As a result of the comparison, when the number of times of startup of the GCLOCK-page replacement unit 122a is equal to or larger than the number of processing targets of the last pre-write execution (YES in step 1206), in step 1207, the GCLOCK-page replacement unit 122a starts up the pre-write management unit 100a via the pre-write startup unit 1000.

Subsequently, in step 1201, the GCLOCK-page replacement unit 122a determines whether the dirty flag 107 of the page set 109 selected in step 1200 is set.

When the GCLOCK-page replacement unit 122a determines in step 1201 that the dirty flag 107 is set (YES in step 1201), in step 1203, the GCLOCK-page replacement unit 122a writes data of the page 105 corresponding to the page set 109 in the secondary storage device 104 and ends the processing.

The processing contents of the GCLOCK-page replacement unit 122a and the conditions for startup of the pre-write management unit 100a are explained above.

After starting up the pre-write management unit 100a, the pre-write startup unit 1000 initializes the number of times of startup of the GCLOCK-page replacement unit 122a managed by the buffer management unit 110a to 0.

The pre-write management unit 100a includes the start-position determination unit 111, the number-of-targets determination unit 112, and a pre-write execution unit 113a. The pre-write management unit 100a is started up according to a startup request from the pre-write startup unit 1000 in the buffer management unit 110a.

First, the pre-write management unit 100a determines, in the start-position determination unit 111, the page set 109 for which pre-write execution is started. Subsequently, the pre-write management unit 100a determines, in the number-of-targets determination unit 112, the number of the processing target page sets 109 of the pre-write execution.

Finally, the pre-write management unit 100a executes the pre-write execution in the pre-write execution unit 113a and ends pre-write processing. Details of the pre-write execution unit 113a are explained below.

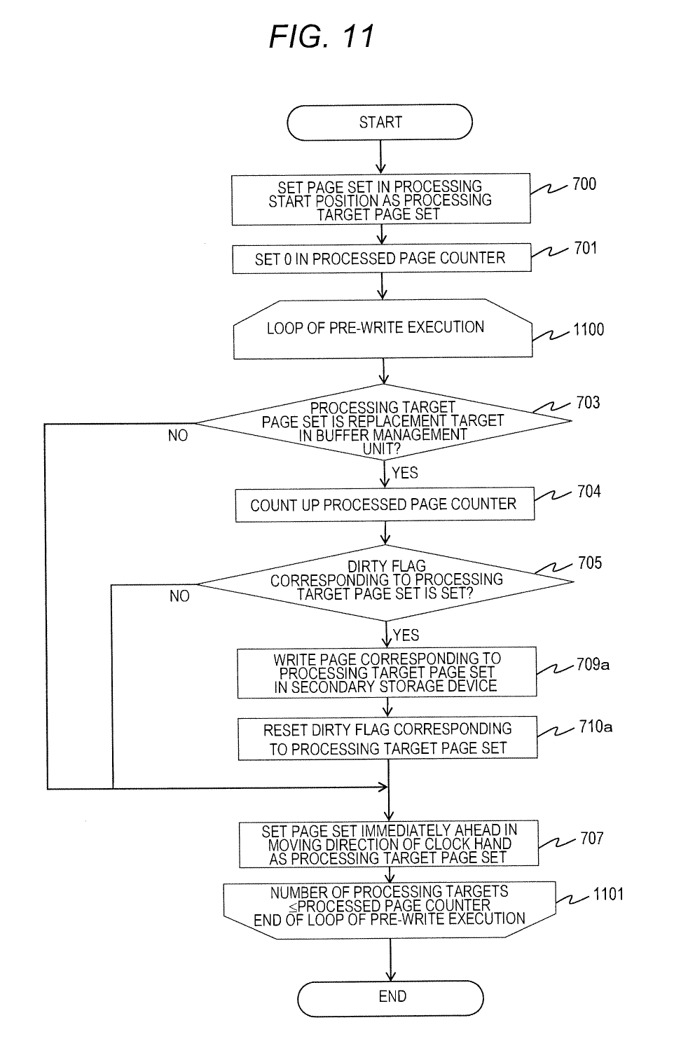

Processing contents of the pre-write execution unit 113a in the second embodiment are explained below with reference to a flowchart of FIG. 11.

Among processing contents shown in FIG. 11, processing contents of steps 700, 701, 703, 704, 705, and 707 are the same as the processing contents in the first embodiment.

First, the pre-write execution unit 113a executes the processing in steps 700 and 701. Subsequently, in step 1100, the pre-write execution unit 113a repeats the processing in step 703 to step 1101 until a count value of a processed page counter managed by the pre-write execution unit 113a increases to be equal to or larger than the number of processing targets set by the number-of-targets determination unit 112.

In this repetition processing, first, in step 703, the pre-write execution unit 113a determines whether the processing target page set 109 is a replacement target in the buffer management unit 110a. When the page set 109 is the replacement target (YES in step 703), in step 704, the pre-write execution unit 113a counts up a count value of the processed page counter. Conversely, when the page set 109 is not the replacement target (NO in step 703), the pre-write execution unit 113a proceeds to processing in step 707.

Subsequently, in step 705, the pre-write execution unit 113a determines whether the dirty flag 107 corresponding to the page set 109 is set. When the dirty flag 107 is set (YES in step 705), in step 709a, the pre-write execution unit 113a writes data of the page 105 corresponding to the page set 109 in the secondary storage device 104. Conversely, when the dirty flag 107 is not set (NO in step 705), the pre-write execution unit 113a proceeds to the processing in step 707.

Subsequently, in step 710a, the pre-write execution unit 113a resets the dirty flag 107 corresponding to the page set 109. Finally, in step 706, the pre-write execution unit 113a sets, as a new processing target, the page set 109 located immediately ahead in the moving direction of the CLOCKHAND viewed from the page set 109 set as the processing target.

The processing contents of the pre-write execution unit 113a are explained above.

As explained above, according to the second embodiment, the buffer management unit 110a can control the startup of the pre-write processing.

Specifically, the buffer management unit 110a starts up the pre-write processing when the number of the page sets 109 same as the number of the page sets 109 processed in the immediately preceding pre-write processing are selected as replacement targets in the page replacement processing in the buffer management unit 110a.

Consequently, for example, even when the replacement processing for a large amount of the pages 105 occurs in a short period, in the buffer management unit 110, the CLOCKHAND passes the page set 109 processed last in the immediately preceding pre-write processing, and the write processing for the pages 105 occurs in the buffer management, it is possible to further suppress occurrence of the page write processing in the buffer management than in the first embodiment by starting the immediately following pre-write processing.

In the second embodiment, only the buffer management unit 110a controls the startup of the pre-write management unit 100a. However, the buffer management unit 110 may start up the pre-write management unit 100 only when the CLOCKHAND passes the page set 109 processed last in the immediately preceding pre-write processing in the pre-write processing in which the pre-write management unit 100 basically manages the startup of the pre-write management unit 100 as in the first embodiment.

### Third Embodiment

A third embodiment can be combined with both the first and second embodiments.

The database management system 120 explained in the third embodiment adopts a configuration same as the configuration in the first embodiment (FIG. 1) or the second embodiment (FIG. 10). The third embodiment is different from the first embodiment and the second embodiment in processing of a pre-write execution unit 113b (not shown).

Differences from the first embodiment and the second embodiment are mainly explained below. Explanation of features common to those in the first embodiment and the second embodiment is omitted or simplified.

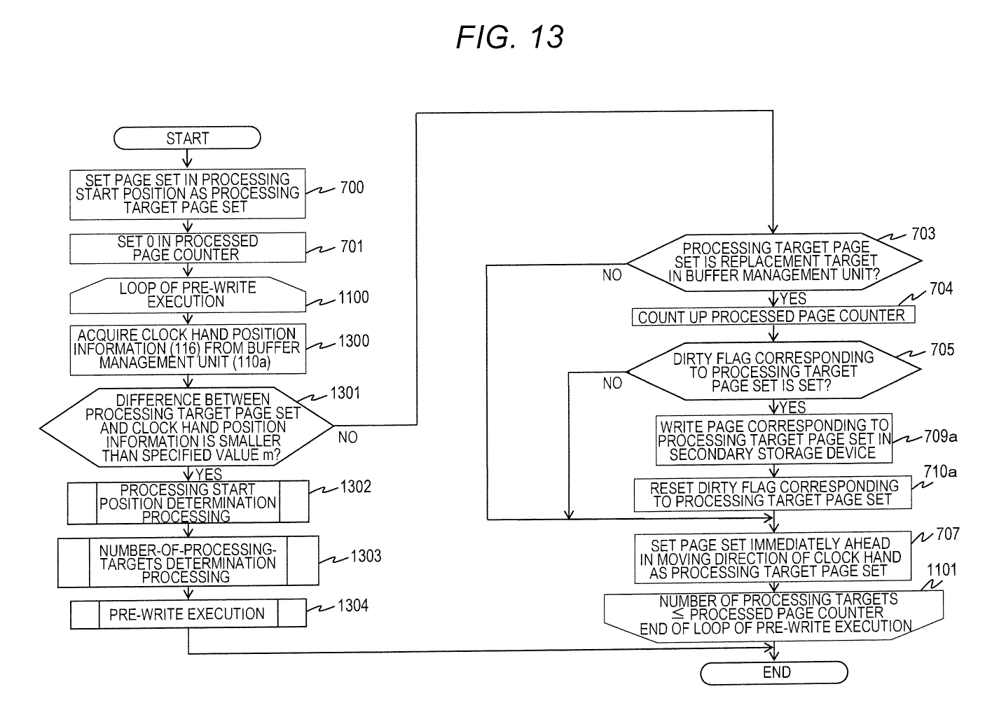

FIG. 13 is a flowchart for explaining processing contents of the pre-write execution unit 113b in the third embodiment. In FIG. 13, a part of the processing of the pre-write execution unit 113a in the second embodiment is changed. In particular, processing in steps 1300 to 1304 is different from the processing in the second embodiment.

The processing contents of the pre-write execution unit 113b in this embodiment are explained below with reference to the flowchart of FIG. 13.

In the repetition processing in step 1100 and subsequent steps, first, in step 1300, the pre-write execution unit 113b acquires the CLOCKHAND position information 116 from the buffer management unit 110a.

Subsequently, in step 1301, the pre-write execution unit 113b calculates a difference between the processing target page set 109 in the repetition processing and the CLOCKHAND position information 116 and determines whether the calculated difference is smaller than the specified value m. In other words, the pre-write execution unit 113b determines whether the processing target page set 109 has been overtook by the CLOCKHAND or is likely to be overtook by the CLOCKHAND soon.

When the calculated difference is smaller than the specified value m, determining that the processing target page set 109 has been overtook (or is likely to be overtook soon) by the CLOCKHAND, in step 1302, the pre-write execution unit 113b starts up the start-position determination unit 111 and executes resetting of a processing start position in the pre-write execution unit 113b.

Subsequently, in step 1303, the pre-write execution unit 113b starts up the number-of-targets determination unit 112 and executes resetting of the number of processing targets in the pre-write management unit.

Finally, in step 1304, the pre-write execution unit 113b starts up the pre-write execution unit 113b and ends the processing of the pre-write execution unit 113b.

ON the other hand, when the calculated difference is equal to or larger than the specified value m and the processing target page set 109 has not been overtook (or is unlikely to be overtook soon) by the CLOCKHAND, the pre-write execution unit 113b shifts to step 703. Processing other than steps 1300, 1301, 1302, 1303, and 1304 is the same as the processing of the pre-write execution unit 113a.

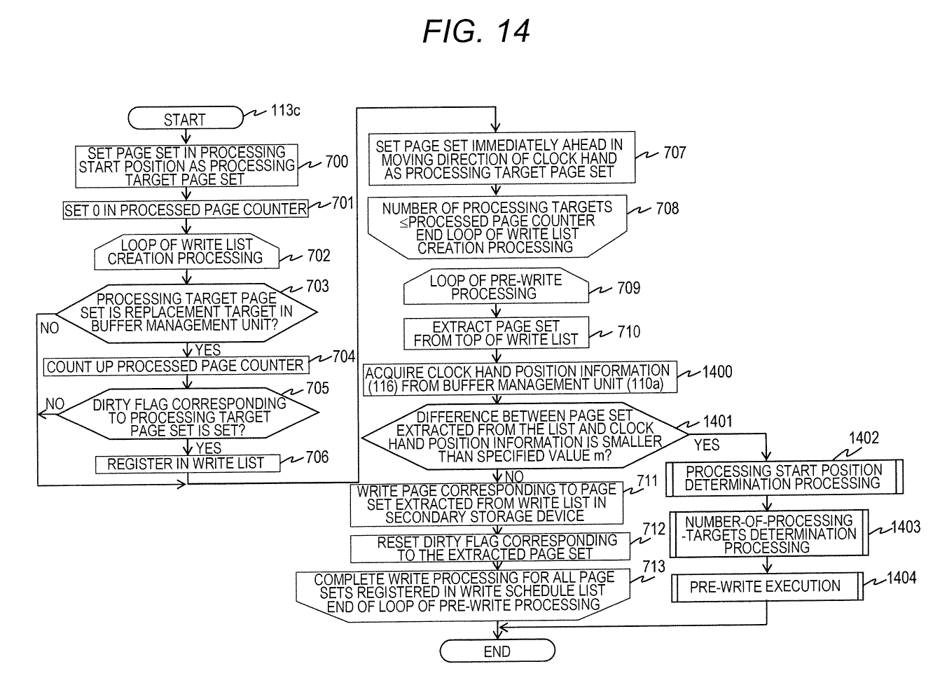

FIG. 14 is a flowchart for explaining processing contents of a pre-write execution unit 113c (not shown) in which a part of the processing of the pre-write execution unit 113 in the first embodiment is changed.

The processing contents of the pre-write execution unit 113c in the third embodiment are explained with reference to the flowchart of FIG. 14.

In step 709, the pre-write execution unit 113c repeats the processing in step 710 to step 713 until no page set 109 registered in the write list remains.

In the repetition processing, first, in step 710, the pre-write execution unit 113c extracts one page set 109 from the top of the write list. Thereafter, in step 1400, the pre-write execution unit 113c acquires the CLOCKHAND position information 116 from the buffer management unit 110.

Subsequently, in step 1401, the pre-write execution unit 113c calculates a difference between the extracted page set 109 and the CLOCKHAND position information 116 and determines whether the calculated difference is smaller than the specified value m. In other words, the pre-write execution unit 113c determines whether the extracted page set 109 has been overtook (or is likely to be overtook soon) by the CLOCKHAND.

When the difference is smaller than the specified value m (YES in step 1401), in step 1402, the pre-write execution unit 113c starts up the start-position determination unit 111 and executes resetting of a processing start position in the pre-write execution unit 113c.

Subsequently, in step 1403, the pre-write execution unit 113c starts up the number-of-targets determination unit 112 and executes resetting of the number of processing targets in the pre-write execution unit 113c.

Finally, in step 1404, the pre-write execution unit 113c starts up the pre-write execution unit 113c and ends the processing of the pre-write execution unit 113c.

Processing other than the steps 1400, 1401, 1402, 1403, and 1404 is the same as the processing of the pre-write execution unit 113.

As explained above, according to this embodiment, immediately before executing the write processing in the pre-write execution, the pre-write execution unit 113c acquires the CLOCKHAND position information 116 and calculates a difference between the CLOCKHAND position information 116 and the position of the page set 109 for which the write processing is executed. When the calculated difference is smaller than the specified value m (the replacement target page 105 of the page replacement processing overtakes the processing target page 105 of the pre-write processing), the pre-write execution unit 113c executes the determination processing for a processing start position, the determination processing for the number of processing targets, and the pre-write execution again. Consequently, it is possible to further suppress occurrence of the page write processing in the buffer management than in the first embodiment or the second embodiment.

In the buffer management unit 110 and the pre-write management unit 100, the page sets 109 to be set as write targets do not compete with each other.

The first to third embodiments are explained above as the embodiments of the present invention. However, the embodiments are examples for the explanation of the present invention and are not intended to limit the scope of the present invention to only the embodiments.

For example, in the embodiments, the database management system 120 is explained as the example. However, the present invention is applicable to any system as long as the system requires the buffer management.

For example, in the embodiments, the example in which the GCLOCK is applied to the algorithm for determining allocation of resources of data is explained. However, besides the GCLOCK, the algorithm may be an algorithm for searching for the page 105 to be set as a replacement target while tracking the circular list 130 of the page sets 109 in order.

In the system incorporating the buffer management to which the algorithm is applied, it is possible to keep a fixed response of the buffer management processing. Further, it is possible to improve the through-put of the system.

1. A data processing method for a computer including a main storage device including a plurality of input and output buffers that temporarily store data, a secondary storage device that stores the data, a buffer management unit that manages replacement processing for the data temporarily stored in the input and output buffers and the data stored in the secondary storage device, and a pre-write management unit that manages pre-write processing for performing pre-write before the data stored in the input and output buffers is written by the buffer management unit, the data processing method comprising:
a step of the buffer management unit selecting, in carrying out the replacement processing, the input and output buffer to be set as a replacement target of the data while referring to the input and output buffers in order;
a step of the buffer management unit measuring a number of times of replacement execution, which is a number of times replacement of data is applied to the input and output buffers per a predetermined time;
a step of the buffer management unit calculating reference speed for referring to, in order, the data stored in the plurality of input and output buffers per the predetermined time;
a step of the pre-write management unit detecting an execution opportunity of the pre-write processing and selecting, on the basis of position information of the input and output buffer subjected to the pre-write processing last time, position information of the input and output buffer currently referred to by the buffer management unit, and the number of times of replacement execution, the input and output buffer to be set as a target of present pre-write processing;
a step of the pre-write management unit writing, when updated data is present in the input and output buffer serving as a candidate to be subjected to the pre-write processing, the data stored in the input and output buffer; and
a step of the pre-write management unit determining, on the basis of the reference speed, a processing execution opportunity of next pre-write processing.

2. The data processing method according to claim 1, wherein, in the step of the pre-write management unit selecting the target input and output buffer to be set as a target of the present pre-write processing, the pre-write management unit selects a candidate to be subjected to the present pre-write processing such that the candidate is referred to earlier than the input and output buffer selected as the replacement target and a difference between a number of times of reference to the input and output buffer and a number of times of reference to a predetermined number of the input and output buffers is within a fixed range.

3. The data processing method according to claim 1, further comprising a step of selecting the input and output buffer, a number of times of reference to which is equal to or smaller than a fixed value, as the replacement target in the step of the buffer management unit selecting the replacement target input and output buffer.

4. The data processing method according to claim 1, further comprising a step of the buffer management unit acquiring position information of the input and output buffer subjected to last pre-write processing and position information of the input and output buffer currently referred to by the buffer management unit, wherein
the step of the pre-write management unit selecting the input and output buffer serving as a candidate to be subjected to the present pre-write processing includes a step of calculating a difference between the position information of the input and output buffer subjected to the last pre-write processing and the position information of the input and output buffer currently referred to by the buffer management unit and setting, according to the difference, the input and output buffer serving as a start position of the present pre-write processing.

5. The data processing method according to claim 1, further comprising a step of the buffer management unit counting the number of times of replacement execution from a point further in a past than a start point of last pre-write processing until an end point of start position determination processing of the present pre-write processing and counting the number of times of replacement execution from the start point of the last pre-write processing until the end point of the start position determination processing of the present pre-write processing, wherein
the step of the pre-write management unit selecting the input and output buffer serving as a candidate to be subjected to the present pre-write processing includes a step of the pre-write management unit setting, on the basis of a difference between both the numbers of times of replacement execution, a number of processed input and output buffers to be subjected to processing in the present pre-write processing.

6. The data processing method according to claim 1, wherein, in the step of the pre-write management unit determining a processing execution opportunity of the next pre-write processing on the basis of the reference speed, the pre-write management unit calculates, on the basis of the reference speed, time until the buffer management unit refers to the input and output buffer present in a position obtained by subtracting a predetermined number from a position of the input and output buffer set as a target of the pre-write processing last among the input and output buffers selected in the step of selecting the input and output buffer to be set as a target of the present pre-write processing and sets a result of the calculation as an execution opportunity of the next pre-write processing.

7. A data processing apparatus comprising:
a main storage device including a plurality of input and output buffers that temporarily store data;
a secondary storage device that stores the data in order to back up the data; and
a controller that controls the main storage device and the secondary storage device, wherein
the controller includes:
a buffer management unit that manages replacement processing for data between the input and output buffers and the secondary storage device; and
a pre-write management unit that manages pre-write processing for performing pre-write before the data stored in the input and output buffers is written by the buffer management unit,
the buffer management unit selects, in carrying out the replacement processing, the input and output buffer to be set as a replacement target of the data while referring to the input and output buffers in order, measures a number of times of replacement execution, which is a number of times replacement of data is applied to the input and output buffers per a predetermined time, and calculates reference speed for referring to, in order, the data stored in the plurality of input and output buffers per the predetermined time,
the pre-write management unit detects an execution opportunity of the pre-write processing, selects, on the basis of position information of the input and output buffer subjected to the pre-write processing last time, position information of the input and output buffer currently referred to by the buffer management unit, and the number of times of replacement execution, the input and output buffer to be set as a target of present pre-write processing, writes, when updated data is present in the input and output buffer serving as a candidate to be subjected to the pre-write processing, the data stored in the input and output buffer, and determines, on the basis of the reference speed, a processing execution opportunity of next pre-write processing.

8. The data processing apparatus according to claim 7, wherein, when the pre-write management unit selects the target input and output buffer to be set as a target of the present pre-write processing, the pre-write management unit selects a candidate to be subjected to the present pre-write processing such that the candidate is referred to earlier than the input and output buffer selected as the replacement target and a difference between a number of times of reference to the input and output buffer and a number of times of reference to a predetermined number of the input and output buffers is within a fixed range.

9. The data processing apparatus according to claim 7, wherein, when the buffer management unit selects the replacement target input and output buffer, the buffer management unit selects the input and output buffer, a number of times of reference to which is equal to or smaller than a fixed value, as the replacement target.

10. The data processing apparatus according to claim 7, wherein
the buffer management unit further acquires position information of the input and output buffer subjected to last pre-write processing and position information of the input and output buffer currently referred to by the buffer management unit, and
when the pre-write management unit selects the input and output buffer serving as a candidate to be subjected to the present pre-write processing, the pre-write management unit calculates a difference between the position information of the input and output buffer subjected to the last pre-write processing and the position information of the input and output buffer currently referred to by the buffer management unit and sets, according to the difference, the input and output buffer serving as a start position of the present pre-write processing.

11. The data processing apparatus according to claim 7, wherein
the buffer management unit counts the number of times of replacement execution from a point further in a past than a start point of last pre-write processing until an end point of start position determination processing of the present pre-write processing and further counts the number of times of replacement execution from the start point of the last pre-write processing until the end point of the start position determination processing of the present pre-write processing, and
when the pre-write management unit selects the input and output buffer serving as a candidate to be subjected to the present pre-write processing, the pre-write management unit sets, on the basis of a difference between both the numbers of times of replacement execution, a number of processed input and output buffers to be subjected to processing in the present pre-write processing.

12. The data processing apparatus according to claim 7, wherein, when the pre-write management unit determines a processing execution opportunity of the next pre-write processing on the basis of the reference speed, the pre-write management unit calculates, on the basis of the reference speed, time until the buffer management unit refers to the input and output buffer present in a position obtained by subtracting a predetermined number from a position of the input and output buffer set as a target of the pre-write processing last among the input and output buffers selected as the input and output buffer to be set as a target of the present pre-write processing and sets a result of the calculation as an execution opportunity of the next pre-write processing.

13. A data processing program for a computer including a main storage device including a plurality of input and output buffers that temporarily store data, a secondary storage device that stores the data, and a control unit that performs management of replacement processing for the data temporarily stored in the input and output buffers and the data stored in the secondary storage device and management of pre-write processing for performing pre-write before the data stored in the input and output buffers is written in the secondary storage device by the replacement processing, the data processing program causing the computer to realize:
a function of grasping the input and output buffers as a fixed circular list and selecting, in carrying out the replacement processing, the input and output buffer to be set as a replacement target of the data while referring to the input and output buffers in order;
a function of measuring a number of times of replacement execution, which is a number of times replacement of data is applied to the input and output buffers per a predetermined time;
a function of calculating reference speed for referring to, in order, the data stored in the plurality of input and output buffers per the predetermined time;
a function of detecting an execution opportunity of the pre-write processing and selecting, on the basis of position information of the input and output buffer subjected to the pre-write processing last time, position information of the input and output buffer currently referred to by the buffer management unit, and the number of times of replacement execution, the input and output buffer to be set as a target of present pre-write processing;
a function of writing, when updated data is present in the input and output buffer serving as a candidate to be subjected to the pre-write processing, the data stored in the input and output buffer; and
a function of determining, on the basis of the reference speed, a processing execution opportunity of next pre-write processing.

14. The data processing program according to claim 13, further causing the computer to realize a function of, in selecting the input and output buffer to be set as a target of the present pre-write processing, selecting a candidate to be subjected to the present pre-write processing such that the candidate is referred to earlier than the input and output buffer selected as the replacement target and a difference between a number of times of reference to the input and output buffer and a number of times of reference to a predetermined number of the input and output buffers is within a fixed range.

15. The data processing program according to claim 13, further causing the computer to realize a function of, in selecting the replacement target input and output buffer, selecting the input and output buffer, a number of times of reference to which is equal to or smaller than a fixed value, as the replacement target.

16. The data processing program according to claim 13, further causing the computer to realize:
a function of acquiring position information of the input and output buffer subjected to last pre-write processing and position information of the input and output buffer currently referred to by the buffer management unit; and
a function of calculating, in selecting the input and output buffer serving as a candidate to be subjected to the present pre-write processing, a difference between the position information of the input and output buffer subjected to the last pre-write processing and the position information of the input and output buffer currently referred to by the buffer management unit and setting, according to the difference, the input and output buffer serving as a start position of the present pre-write processing.

17. The data processing program according to claim 13, further causing the computer to realize:
a function of counting the number of times of replacement execution from a point further in a past than a start point of last pre-write processing until an end point of start position determination processing of the present pre-write processing and counting the number of times of replacement execution from the start point of the last pre-write processing until the end point of the start position determination processing of the present pre-write processing; and
a function of setting, in selecting the input and output buffer serving as a candidate to be subjected to the present pre-write processing, on the basis of a difference between both the numbers of times of replacement execution, a number of processed input and output buffers to be subjected to processing in the present pre-write processing.

18. The data processing program according to claim 13, further causing the computer to realize a function of calculating, in determining a processing execution opportunity of the next pre-write processing on the basis of the reference speed, on the basis of the reference speed, time until the buffer management unit refers to the input and output buffer present in a position obtained by subtracting a predetermined number from a position of the input and output buffer set as a target of the pre-write processing last among the input and output buffers selected as the input and output buffer to be set as a target of the present pre-write processing and setting a result of the calculation as an execution opportunity of the next pre-write processing.

19. A data processing method for a computer including a main storage device including a plurality of input and output buffers that temporarily store data, a secondary storage device that stores the data, a buffer management unit that manages replacement processing for the data temporarily stored in the input and output buffers and the data stored in the secondary storage device, and a pre-write management unit that manages pre-write processing for performing pre-write before the data stored in the input and output buffers is written by the buffer management unit, the data processing method comprising:
a step of the buffer management unit selecting, in carrying out the replacement processing, the input and output buffer to be set as a replacement target of the data while referring to the input and output buffers in order;
a step of the buffer management unit measuring a number of times of replacement execution, which is a number of times replacement of data is applied to the input and output buffers per a predetermined time;
a step of the buffer management unit calculating reference speed for referring to, in order, the data stored in the plurality of input and output buffers per the predetermined time;
a step of the buffer management unit starting up the pre-write processing when the number of times of replacement execution is equal to or larger than a number of the input and output buffers set as targets of last pre-write processing;
a step of the pre-write management unit selecting, on condition that the pre-write processing is started up by the buffer management unit, on the basis of position information of the input and output buffer subjected to the pre-write processing last time, position information of the input and output buffer currently referred to by the buffer management unit, and the number of times of replacement execution, the input and output buffer to be set as a target of present pre-write processing; and
a step of the pre-write management unit writing, when updated data is present in the input and output buffer serving as a candidate to be subjected to the pre-write processing, the data stored in the input and output buffer.

20. A data processing method for a computer including a main storage device including a plurality of input and output buffers that temporarily store data, a secondary storage device that stores the data, a buffer management unit that manages replacement processing for the data temporarily stored in the input and output buffers and the data stored in the secondary storage device, and a pre-write management unit that manages pre-write processing for performing pre-write before the data stored in the input and output buffers is written by the buffer management unit, the data processing method comprising:
a step of the buffer management unit selecting, in carrying out the replacement processing, the input and output buffer to be set as a replacement target of the data while referring to the input and output buffers in order;
a step of the buffer management unit measuring a number of times of replacement execution, which is a number of times replacement of data is applied to the input and output buffers per a predetermined time;
a step of the buffer management unit calculating reference speed for referring to, in order, the data stored in the plurality of input and output buffers per the predetermined time;
a step of the pre-write management unit detecting an execution opportunity of the pre-write processing and selecting, on the basis of position information of the input and output buffer subjected to the pre-write processing last time, position information of the input and output buffer currently referred to by the buffer management unit, and the number of times of replacement execution, the input and output buffer to be set as a target of present pre-write processing;
a step of the pre-write management unit selecting again, when a difference between the position information of the input and output buffer currently referred to by the buffer management unit and the position information of the input and output buffer serving as a candidate to be subjected to the pre-write processing is smaller than a specified value, on the basis of the position information of the input and output buffer subjected to the pre-write processing last time, the position information of the input and output buffer currently referred to by the buffer management unit, and the number of times of replacement execution, the input and output buffer to be set as a target of the present pre-write processing;
a step of the pre-write management unit writing, when a difference between the position information of the input and output buffer currently referred to by the buffer management unit and the position information of the input and output buffer to be set as candidate to be subjected to the pre-write processing is equal to or larger than the specified value and when updated data is present in the input and output buffer serving as a candidate to be subjected to the pre-write processing, the data stored in the input and output buffer; and
a step of the pre-write management unit determining, on the basis of the reference speed, a processing execution opportunity of next pre-write processing.
